(19) United States
(12) Patent Application Publication
(10) Pub. No.: US 2023/0394396 A1
(43) Pub. Date: Dec. 7, 2023

(54) POINTS PROCESSING METHOD

(71) Applicant: MiView Integrated Solutions, LLC, Carrollton, TX (US)

(72) Inventor: Luis A. Uriarte, Frisco, CA (US)

(73) Assignee: MiView Integrated Solutions, LLC, Carrollton, TX (US)

(21) Appl. No.: 18/452,436

(22) Filed: Aug. 18, 2023

Related U.S. Application Data
(63) Continuation-in-part of application No. 17/944,913, filed on Sep. 14, 2022.
Application No. 17/944,913 is a continuation of application No. 17/351,982, filed on Jun. 18, 2021, now Pat. No. 11,481,702.
(60) Provisional application No. 63/399,197, filed on Aug. 18, 2022.
(60) Provisional application No. 63/040,908, filed on Jun. 18, 2020.
(60) Provisional application No. 63/208,739, filed on Jun. 9, 2021.

(51) Int. Cl. G06Q 10/0631; G06Q 50/08; G06Q 10/0875; G06Q 10/10

(52) U.S. Cl. CPC G06Q 10/063114; G06Q 50/08; G06Q 10/063116; G06Q 10/063118; G06Q 10/0875; G06Q 10/103

(57) ABSTRACT

A method implements a points processing method. The method includes extracting work information from a work message to adjust a work record, manipulating an activity record responsive to the work record and a rule including multiple rule attributes to set an activity value of the activity record, and processing the activity record to generate an activity report including the activity value. The method further includes adjusting a user interface responsive to the activity report.

### CROSS REFERENCE TO RELATED APPLICATIONS

This application claims the benefit of U.S. Provisional Application 63/399,197, filed Aug. 18, 2022 and is a continuation in part of U.S. application Ser. No. 17/944,913, filed Sep. 14, 2022; U.S. application Ser. No. 17/944,913 is a continuation of U.S. application Ser. No. 17/351,982, filed Jun. 18, 2021; U.S. application Ser. No. 17/351,982 claims the benefit of U.S. Provisional Application 63/040,908, filed Jun. 18, 2020, and U.S. Provisional Application 63/208,739, filed Jun. 9, 2021. Each of the applications identified above are incorporated by reference herein.

### BACKGROUND

Worksite information management systems track and process information about worksites. Worksite information management systems create, schedule, and track tasks and milestones. Worksite information management systems may also use points and values to track rewards for users of the system. A challenge with worksite information management systems is to track, process, and present values for the points and rewards of users of the worksite information management systems.

### SUMMARY

In general, in one or more aspects, the disclosure relates to a method implementing a points processing method. The method includes extracting work information from a work message to adjust a work record, manipulating an activity record responsive to the work record and a rule including multiple rule attributes to set an activity value of the activity record, and processing the activity record to generate an activity report including the activity value. The method further includes adjusting a user interface responsive to the activity report.

In general, in one or more aspects, the disclosure relates to a system implementing a points processing method. The system includes at least one processor and an application. When executed by the at least one processor, the application extracts work information from a work message to adjust a work record, manipulates an activity record responsive to the work record and a rule including multiple rule attributes to set an activity value of the activity record, and processes the activity record to generate an activity report including the activity value. The application further adjusts a user interface responsive to the activity report.

In general, in one or more aspects, the disclosure relates to a non-transitory computer readable storage medium storing computer readable program code which, when executed by a processor, performs a computer-implemented method. The computer-implemented method includes extracting work information from a work message to adjust a work record, manipulating an activity record responsive to the work record and a rule including multiple rule attributes to set an activity value of the activity record, and processing the activity record to generate an activity report including the activity value. The computer-implemented method further includes adjusting a user interface responsive to the activity report.

Other aspects of the one or more embodiments will be apparent from the following description and the appended claims.

### BRIEF DESCRIPTION OF DRAWINGS

FIG. 1 shows a computing system, in accordance with one or more embodiments of the disclosure.

FIG. 2 shows a method in accordance with one or more embodiments of the disclosure.

FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, FIG. 32, FIG. 33, FIG. 34, FIG. 35, FIG. 36, FIG. 37, FIG. 38, FIG. 39, FIG. 40, FIG. 41, and FIG. 42 show examples in accordance with one or more embodiments of the disclosure.

FIG. 43A and FIG. 43B show a computing system and network environment, in accordance with one or more embodiments of the disclosure.

Like elements in the various figures are denoted by like reference numerals for consistency.

### DETAILED DESCRIPTION

In general, one or more embodiments are directed to methods of points processing and improving the user interfaces that expose the points processing functionality. Users of worksite information management systems operate user devices to earn points, rewards, bonuses, payments, etc., that are tracked, processed, and presented. For example, when a worker finishes up a job at a worksite, values reflecting the points, rewards, bonuses, etc., may accrue to the user and be tracked with database records maintained by the worksite information management system. The points, rewards, bonuses, etc., are displayed on the user devices operated by the users. Additionally, adjustments to the points may be made responsive to requests from the user devices. For example, a user may finish a job late and the system may record a penalty (e.g., a negative value for a reward, bonus, payment, etc.). In response, the user may dispute the penalty by requesting an adjustment through the user device. The adjustment request from the user device may provide an explanation and an image that are used to determine an adjustment to the penalty.

As discussed below in relation to the various figures and associated description, a worksite information management system processes information from user devices to record work records that document work performed at worksites enumerated within the worksite information management system. The work records are processed with rules to generate activity records that quantify the values tracking the points, rewards, bonuses, payments, etc., of the users of the system. The worksite information management system may adjust the user interfaces displayed on the user devices to meaningfully present information from activity reports that consolidate the values tracking the points, rewards, bonuses, payments, etc. The activity reports may correspond to a finite time period (e.g., one week) during which work records identify the completion of work events for which activity records identify the accrual and transfer of values tracking the points, rewards, bonuses, payments, etc.

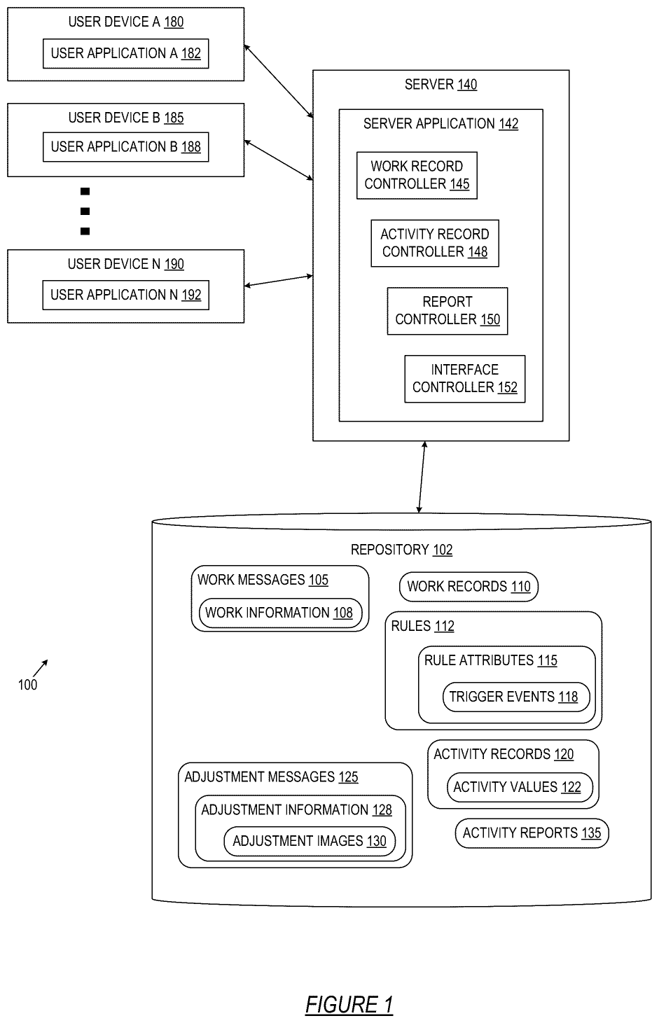

Turning to FIG. 1, the system (100) is a computing system shown in accordance with one or more embodiments that may form part of a worksite information management system. The system (100) processes messages to generate, process, and revise the records stored in the repository (102). The system (100) includes the repository (102), the server application (142), and the user devices A (180) and B (185) through N (190). Embodiments of the system (100) may use different hardware and software components to achieve similar functionality.

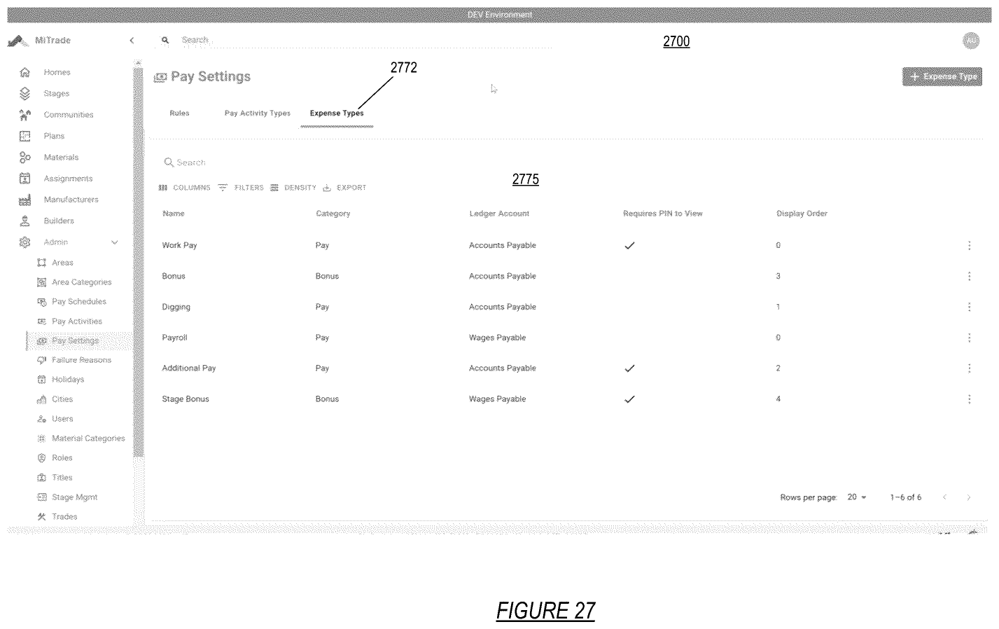

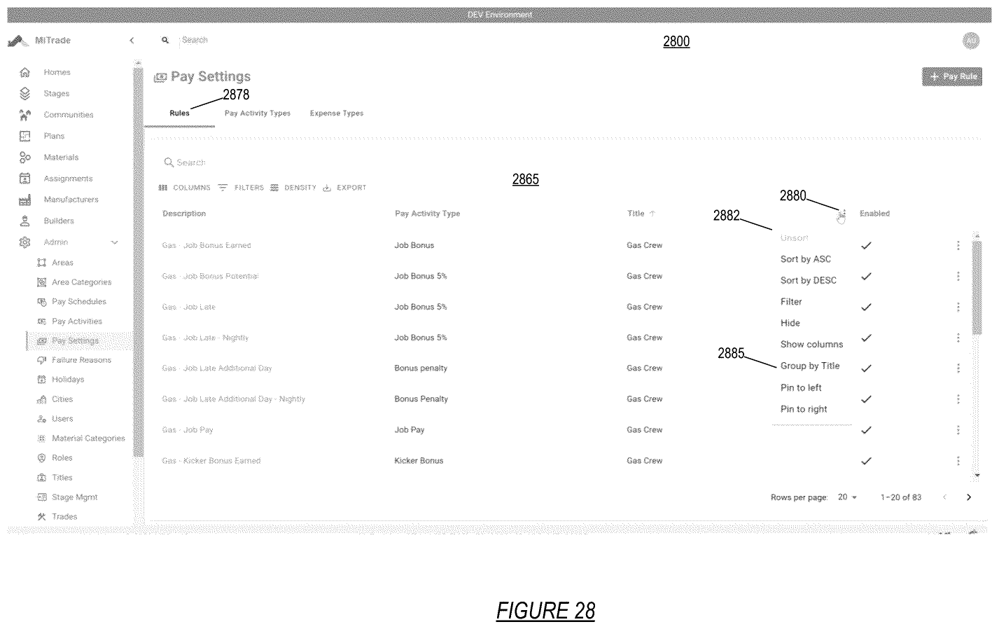

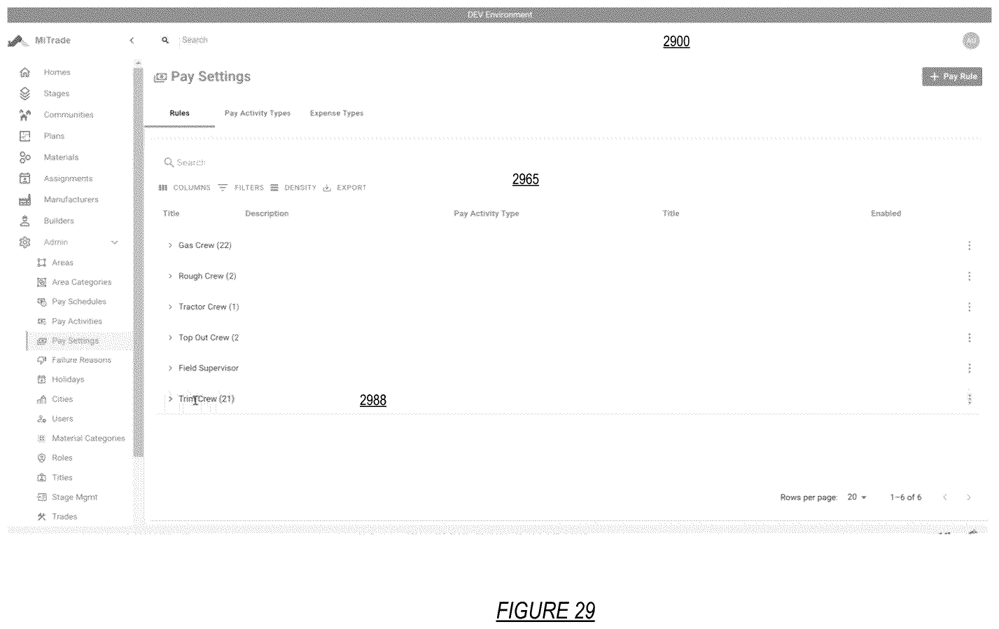

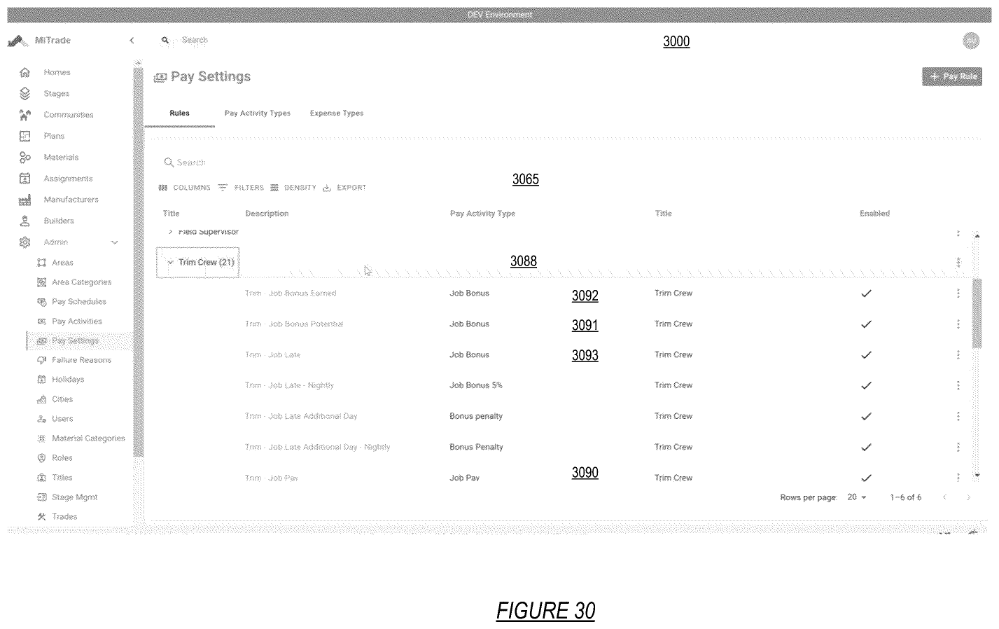

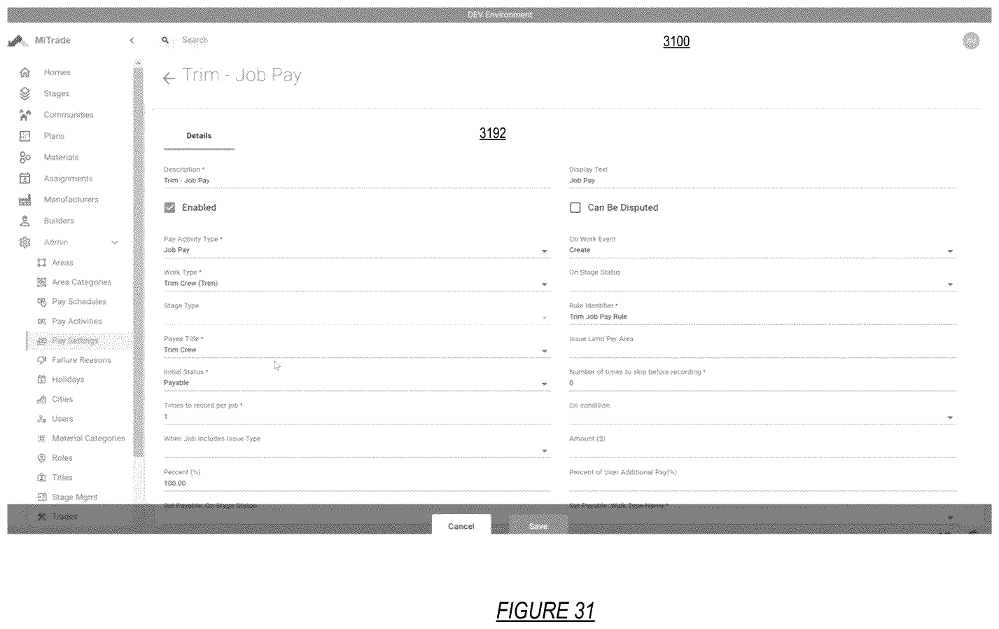

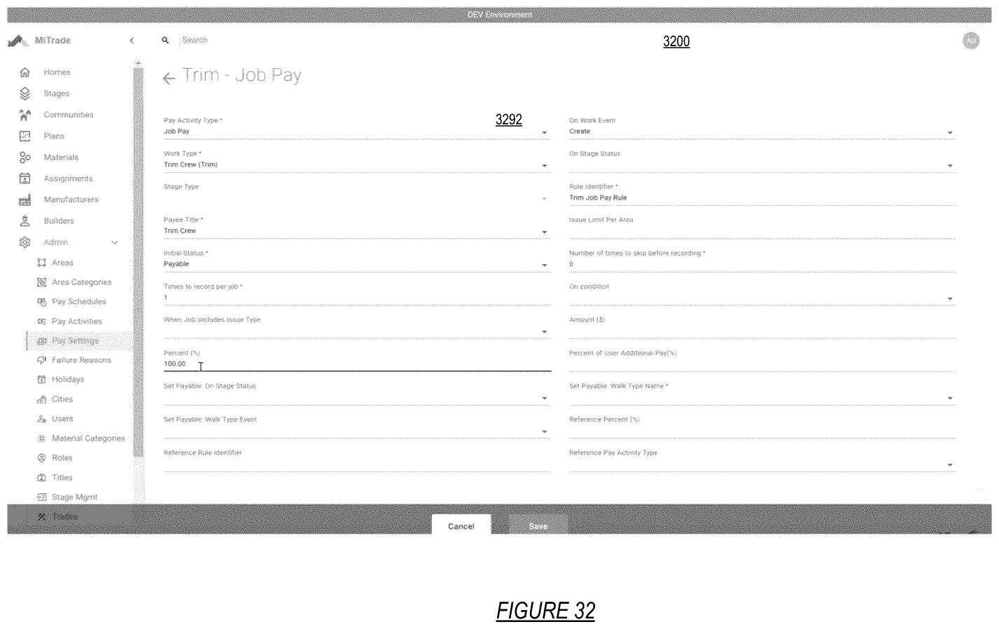

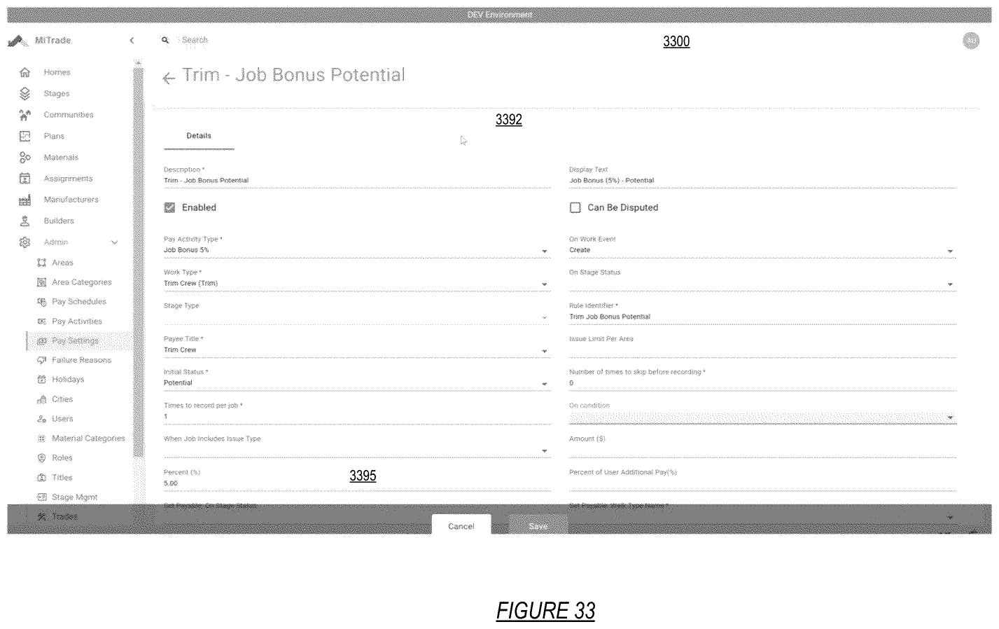

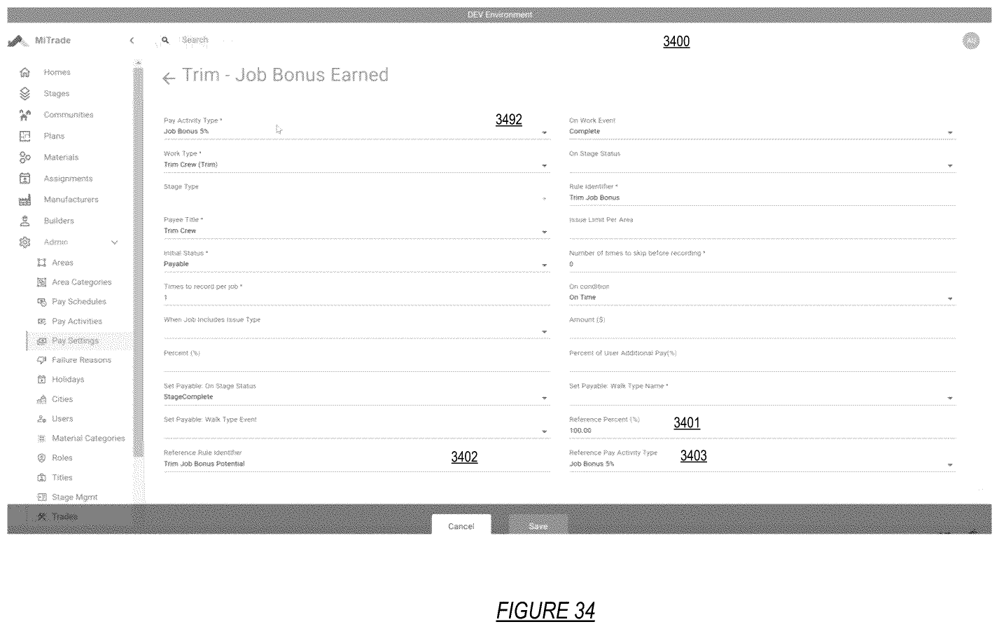

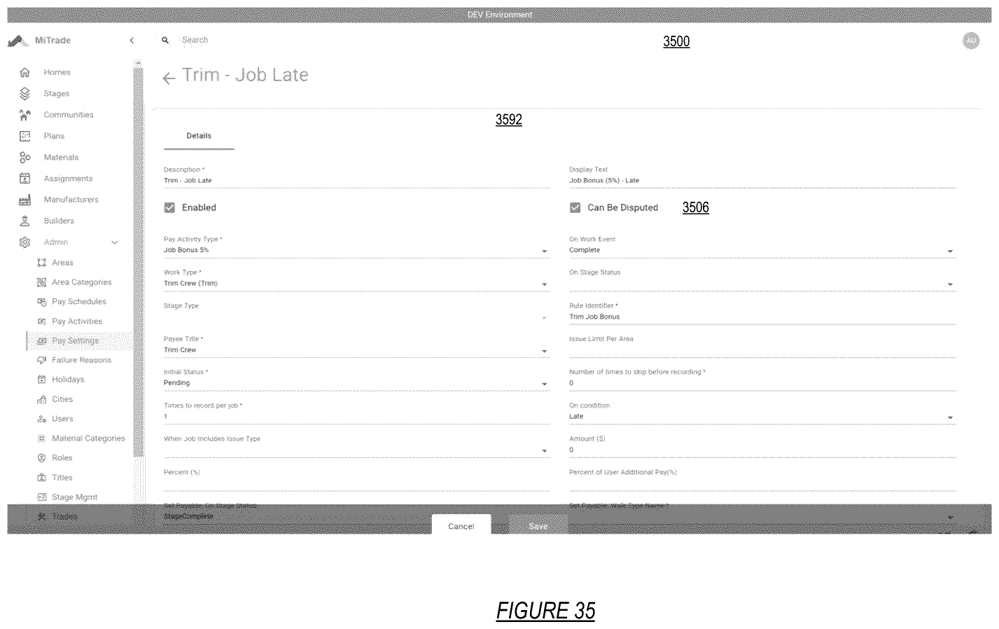

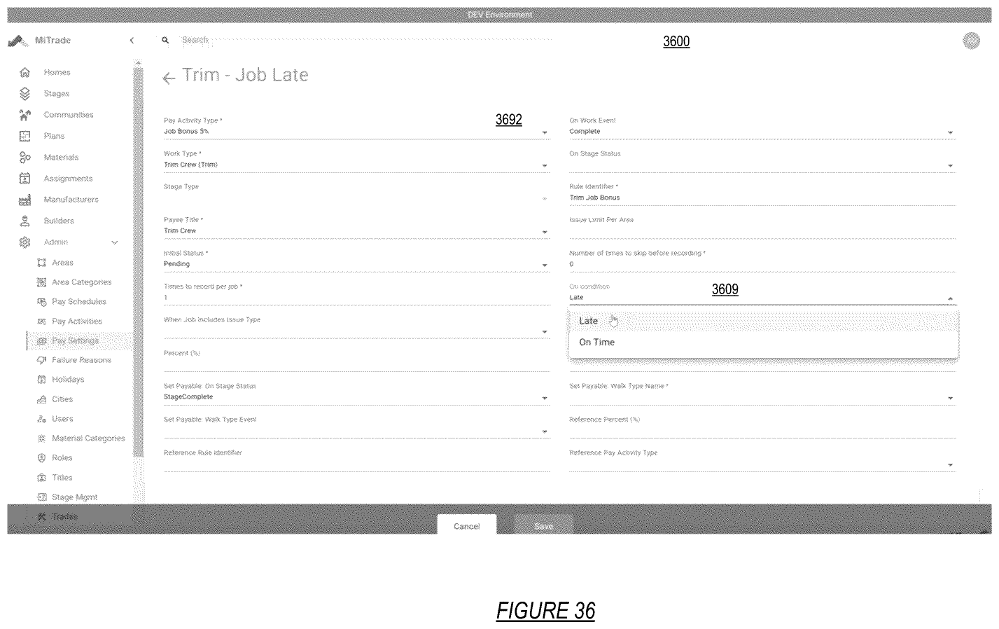

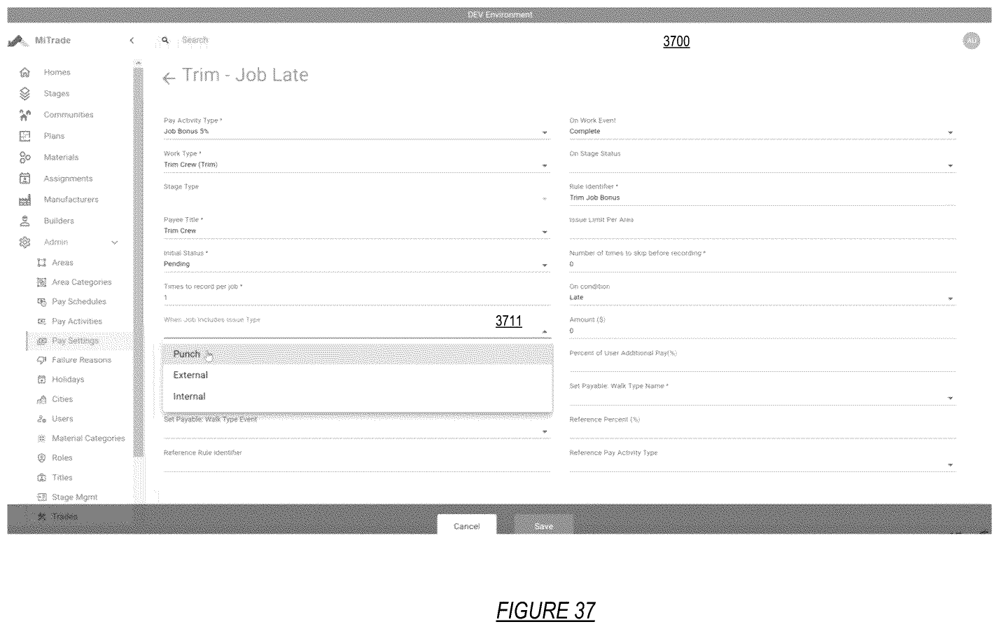

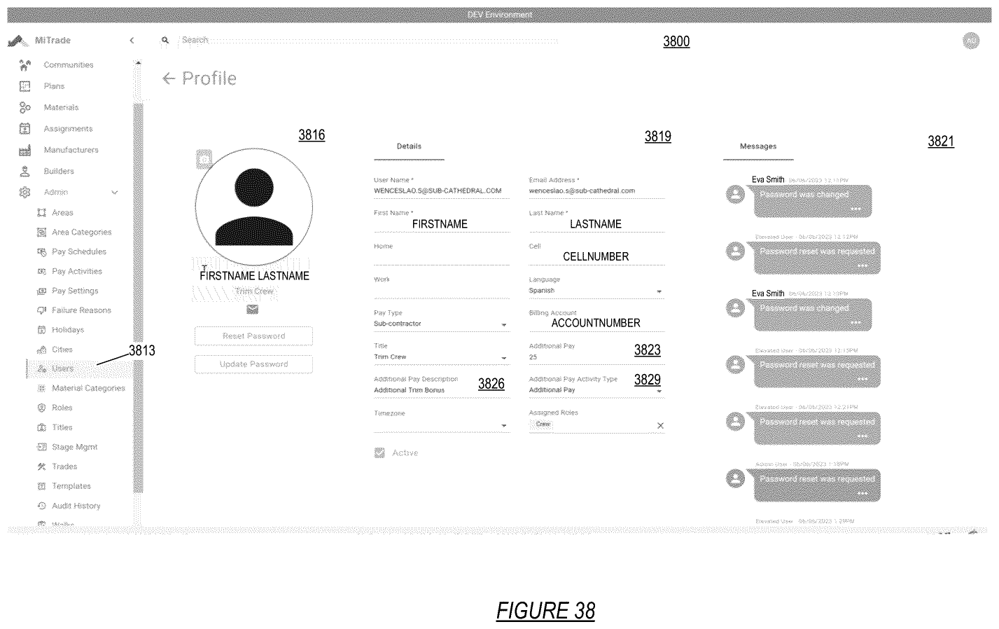

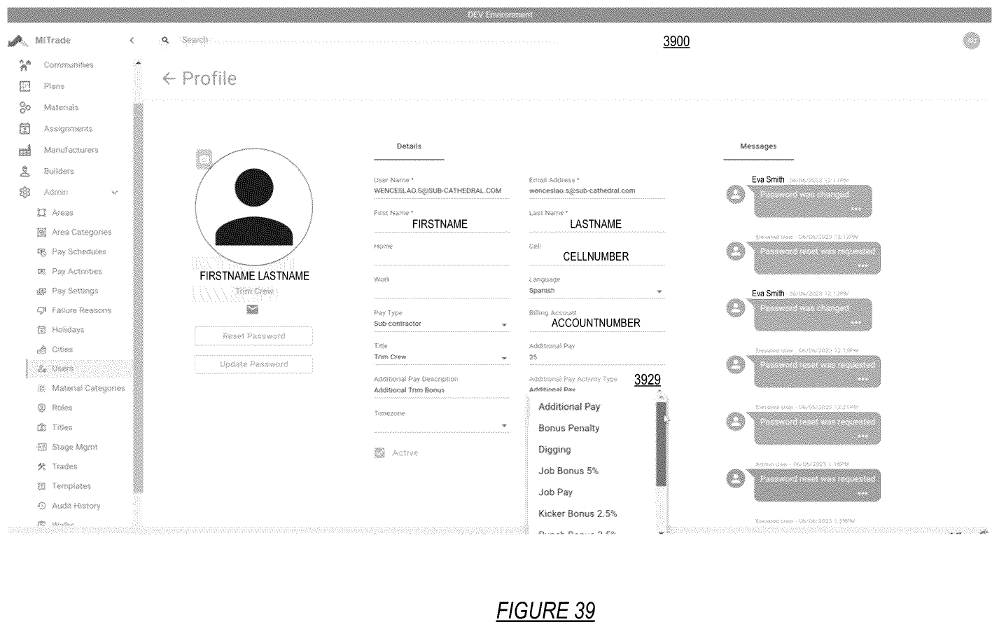

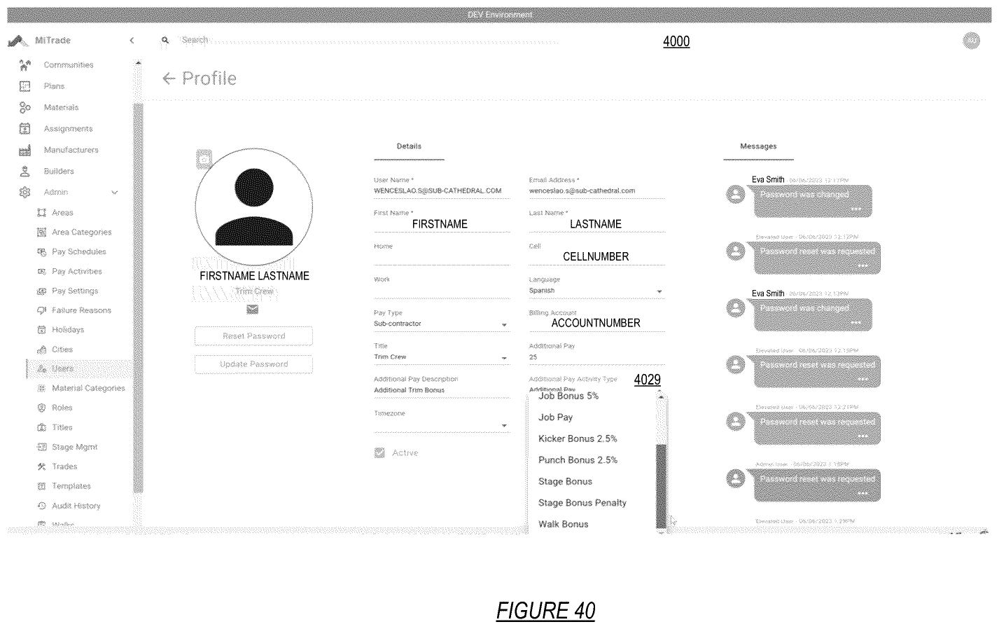

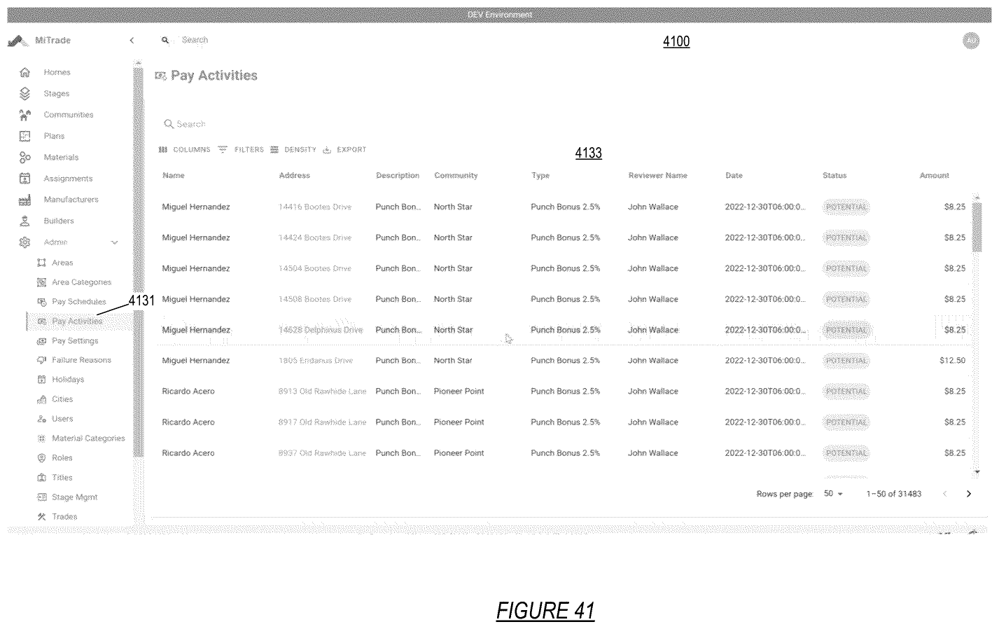

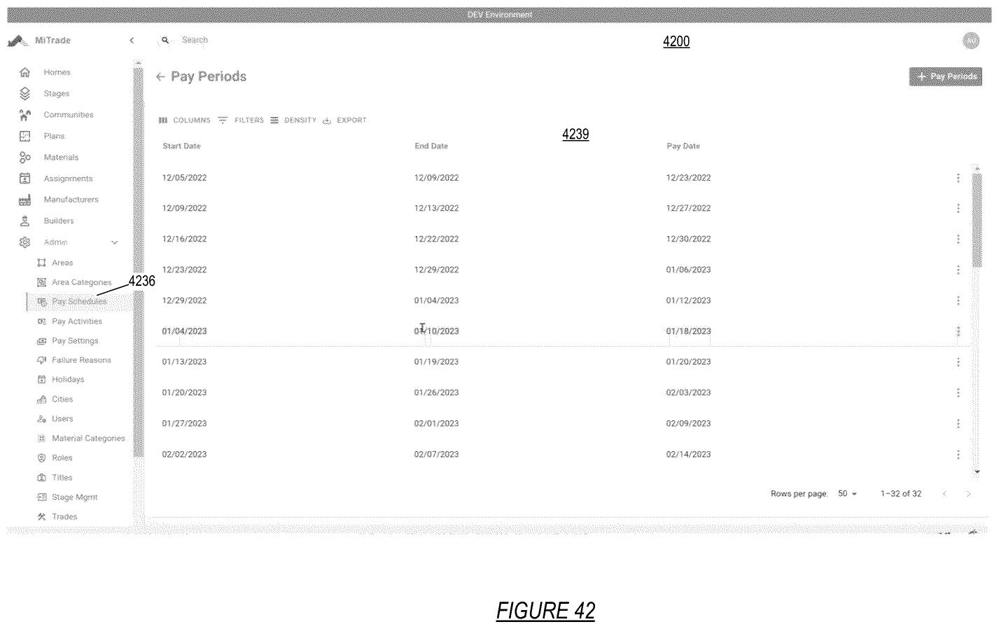

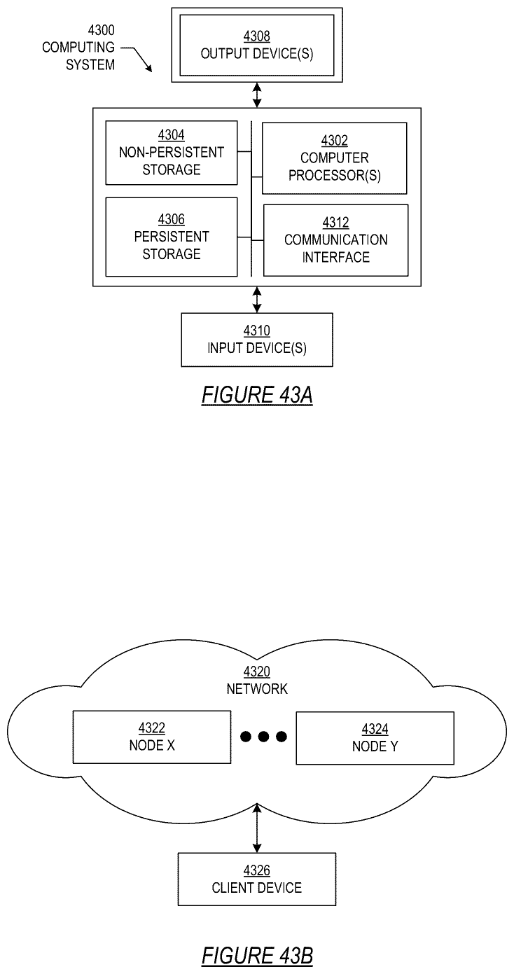

The repository (102) is a type of storage unit and/or device (e.g., a file system, database, data structure, or any other storage mechanism) for storing data and may include one or more of the computing systems (servers, desktop computers, etc.) described in FIGS. 43A and 43B. The repository (102) may include multiple different, potentially heterogeneous, storage units and/or devices. In one embodiment, the repository (102) stores database records that include the work messages (105), the work records (110), the rules (112), the activity records (120), the adjustment messages (125), and the activity reports (135).

The work messages (105) in the repository (102) are messages transmitted between the server (140) and the user devices A (180) and B (185) through N (190). The work messages (105) communicate the work information (108) between the different components of the system (100).

The work information (108) is information managed by the system (100) about work for a worksite. For example, a worksite may be the location of a residential home construction project. The work information (108) may describe the status of the work performed at the worksite and include work images that document the work performed.

The work records (110) are records stored in a database of the repository (102). The work records (110) may include the work information (108) extracted from the work messages (105) and reformatted for storage within the repository (102) and processing by the system (100).

The rules (112) are records stored in a database of the repository (102). The rules (112) define the creation and processing of the activity records (120) based on the information from the work records (110). In one embodiment, one of the rules (112) corresponds to one of the activity records (120). The rules (112) include the rule attributes (115).

The rule attributes (115) are attributes of the rules (112). One of the rules (112) may include several of the rule attributes (115). A rule attribute of the rule attributes (115) may include a description and a value, which may be referred to as an attribute description and an attribute value. The rule attributes (115) for one of the rules (112) may include attributes with the descriptions of “description”, “display text”, “Enabled”, “can be disputed”, “pay activity type”, “on work event”, etc., which are further enumerated and described below at FIG. 34.

The trigger events (118) are events identified in the rule attributes (115) that trigger the rules (112). A trigger event of the trigger events (118) may identify a work event that triggers one of the rules (112) to generate one of the activity records (120). The work event may be identified from an update to one of the work records (110). For example, a worker operates a user device to send one of the work messages (105) to the server (140). Information from the work message processed by the server (140) may include a work image of work completed at a worksite. The information is processed to generate one of the work records (110) that is stored to the repository (102). The storage of the work record may be the trigger event defined by a rule attribute for a rule.

The activity records (120) are records of activity that identify the values of different accounts. The values transferred may represent points, rewards, bonuses, payments, etc., and may be identified with the activity values (122). The activity records (120) may include job records that identify an activity value for a base pay amount for completing a job (also referred to as a work item) at a worksite. The activity records (120) may also include certain activity records that identify an activity value for an activity pay amount related to work performed at a worksite.

The activity values (122) are values that quantify the points, rewards, bonuses, payments, etc., for the activity records (120). One of the activity values (122) may correspond to one of the activity records (120).

The adjustment messages (125) are messages through which adjustments to the activity records (120) may be requested. In one embodiment, one of the adjustment messages (125) may dispute one of the activity records (120). For example, future activity record may be a penalty that is disputed by a user of the system (100). The adjustment messages (125) include the adjustment information (128).

The adjustment information (128) is information in the adjustment messages (125). The adjustment information (128) may be extracted from the adjustment messages (125) and used to process the activity records (120). The adjustment information (128) may include the adjustment images (130).

The adjustment images (130) are images in the adjustment information (128). One of the adjustment images (130) corresponds to one of the adjustment messages (125) for one of the activity records (120). For example, an adjustment image may document the state of the worksite to show that a work item identified as late was unable to be completed on time due to external circumstances (e.g., rain, other precursor work not completed, etc.).

The activity reports (135) are reports of the activity (e.g., transfers of the activity values (122)) of the system (100). The activity reports (135) may include worker reports, trade reports, accounting reports, etc. Worker reports may be displayed on the user device and interface of a worker and present the values for the points, rewards, bonuses, payments, etc., that correspond to the worker. Trade reports may present the values for the points, rewards, bonuses, payments, etc., for a supervisor. The accounting reports may be used to drive an accounting system to transfer points and make additional reports.

Continuing with FIG. 1, the system (100) also may include the server (140). The server (140) is one or more computing systems, possibly in a distributed computing environment. An example of the server (140) may be the computing systems of FIG. 43A and FIG. 43B.

The server (140) may host and execute one or more processes, software, applications, etc. For example, the server (140) may include the server application (142).

The server application (142) includes software or application-specific hardware programmed, when executed by a processor, to process messages, records, and reports. The server (140) may interact with the user devices A (180) and B (185) through N (190) to generate and process the messages, records, and reports in real time. The server application (142) may include the work record controller (145), the activity record controller (148), the report controller (150), and the interface controller (152).

The work record controller (145) processes the work messages (105) received from the user devices A (180) and B (185) through N (190) to generate the work records (110). In one embodiment, the work record controller (145) extracts the work information (108) from the work messages (105) and stores the extracted information in the work records (110).

The activity record controller (148) processes the work records (110) using the rules (112) to generate the activity records (120). In one embodiment, the activity record controller (148) identifies the trigger events (118) (from the rule attributes (115) for the rules (112)) from changes made to the work records (110). The activity record controller (148) may also process the adjustment messages (125) to update the activity records (120).

The report controller (150) processes the activity records (120) to generate the activity reports (135). In one embodiment, the report controller (150) may identify a set of the activity records (120) that corresponds to a set of the work records (110) that document work performed during a time period. In one embodiment, the time period may be weekly, biweekly, monthly, etc. The report controller (150) may aggregate some of the activity values (122) from the set of activity records (120) to generate one or more of the activity reports (135).

The interface controller (152) processes the activity reports (135) to adjust the user interfaces for the user applications A (182) and B (188) through N (192) of the user devices A (180) and B (185) through N (190). The interface controller (152) may change sizes, colors, locations, etc., of the user interface elements displayed by the user applications A (182) and B (188) through N (192). The changes to the user interface elements may be responsive to changes to the activity reports (135), the activity values (122), the activity records (120), the work records (110), etc.

The system (100) may include one or more of the user devices A (180) and B (185) through N (190). The user devices A (180) and B (185) through N (190) are computing systems (e.g., desktops, laptops, mobile phones, tablets, etc.) that are operated by users or by automated processes (e.g., other software that may operate as part of the system (100)). The user devices A (180) and B (185) through N (190) may be used to generate the work messages (105) and adjustment messages (125) and view and manipulate the work records (110), the rules (112), the activity records (120), and activity reports (135).

In one embodiment, one or more of the user devices A (180) and B (185) through N (190) may be administrative devices that are used by administrators of the system (100), worker devices that are used by workers at worksites tracked by the system (100), trade devices that are used by supervisors of the workers, etc. The administrative devices may be used to define the rules (112) and approve adjustment requests from the adjustment messages (125). The worker devices may be used to capture work images, generate adjustment requests, etc. The trade devices may be used to review work images, capture additional work images, review adjustment requests, etc.

Although described within the context of a client server environment with servers and user devices, aspects of the disclosure may be practiced with a single computing system and application. For example, a monolithic application may operate on a computing system to perform the same functions as one or more of the user application A (182), the server application (142), and the repository (102).

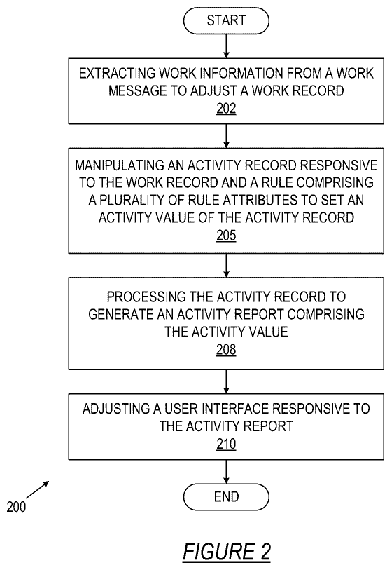

Turning to FIG. 2, the method (200) adjusts user interfaces in response to processing messages, records, and reports. The method (200) may be performed using the system (100) of FIG. 1.

Step 202 of the process (200) includes extracting work information from a work message to adjust a work record. The work information documents work performed at a worksite. The work information is wrapped into a work message, transmitted by a user device, and received by a server. The work information may be extracted by retrieving and reformatting the work information from the work message. For example, string values may be converted to numeric values. After the work information is extracted, work records are adjusted to include the extracted information by modifying the work records and storing the work information into the work records.

Step 205 of the process (200) includes manipulating an activity record responsive to the work record and a rule, having multiple rule attributes, to set an activity value of the activity record. The activity record, associated work record, and rule with various rule attributes, are retrieved. The rule is then applied to the work record by assessing the conditions specified in the rule attributes. When conditions from the rule attributes are met, the activity value of the activity record is manipulated. In one embodiment, multiple attributes may be used to specify a formula used to determine the activity value.

Step 208 of the process (200) includes processing the activity record to generate an activity report that includes the activity value. The activity record is retrieved, and the activity value is extracted. Additional calculations or transformations, which may be specified in the rule attributes, may be performed. The activity report is then generated, encompassing not only the processed activity value but also additional pertinent information, such as details about the associated work record and contextual information (e.g., worksite address). The activity report may be formatted and styled based on the information from the activity record, in the activity value.

Step 210 of the process (200) includes adjusting a user interface responsive to the activity report. The activity report is retrieved, which includes information such as the activity value, details regarding the associated work record, contextual data, etc. Additional calculations or transformations specified in the rule attributes may also be performed. The information from the activity report may be analyzed to determine appropriate adjustments for the user interface. Visual changes, such as alterations in size, color, font, or layout of interface elements, are implemented based on the analyzed data, to effectively represent the information from the activity report. The adjustments may be applied to the user interface in real-time. Users may interact with the modified interface to explore updated information.

In one embodiment, manipulating the activity record responsive to the rule includes identifying a trigger event defined by the rule and includes setting the activity value defined by one or more rule attributes of the rule. The trigger event, which may be periodic or initiated by changes in a work record, is continuously monitored by the computing system. A predefined schedule or timer may be employed for periodic events, and updates to relevant work records are actively observed for change-triggered events. Once the trigger conditions are met, the associated work record is accessed, and the conditions specified in the rule attributes are evaluated against the information in the work record. If the conditions are satisfied, the corresponding activity record may be manipulated according to the rule attributes of the rule.

In one embodiment, manipulating the activity record responsive to the rule includes extracting adjustment information from an adjustment message received responsive to a user interface display of the activity record and includes manipulating the activity record responsive to the adjustment information. The adjustment message is received in response to the user interface display of the activity record, and the adjustment information contained within the message is extracted. The extraction process includes retrieving the adjustment message and parsing the content to isolate and interpret the adjustment information.

The activity record, having been accessed and retrieved, undergoes manipulation based on the adjustment information extracted from the adjustment message. The adjustment information is evaluated against predetermined criteria specified by the rule attributes associated with the activity record. If the criteria align with the extracted adjustment information, alterations to the activity value are made per the instructions provided by the adjustment information.

In one embodiment, the adjustment information, extracted from an adjustment message received responsive to a user interface display of the activity record, includes an adjustment image corresponding to the adjustment message. The adjustment image may document and capture a state of the worksite and be used as evidence for a dispute.

In one embodiment, adjusting the user interface responsive to the activity report includes modifying a list view displaying a plurality of activity records, comprising the activity record, by one or more of resizing the list view, adding an icon, adjusting a color of an activity record, adjusting a font size, adjusting a font color, etc., responsive to the activity record. The list view displaying the activity records is modified by the computing system through actions such as resizing of the list view, adjustment of font size, and alteration of font color, all of which may be responsive to the activity record. The list view may be resized to accommodate varying numbers of activity records, the font size may be adjusted based on the content of the activity record, and the font color may be changed for improved visibility. The modifications may be carried out by the computing system in accordance with the attributes of each activity record, resulting in a user interface presentation that is customized and optimized to the content and context of the activities being displayed.

In one embodiment, the rule attributes are set with an administrator device and may include a work type, a work trigger event, an activity amount, an activity percentage, an activity record type, a flat amount value, etc. The work type identifies the type of work performed. The work trigger event identifies the event that triggers the processing of a rule. The activity amount may specify a fixed amount for an activity. The activity percentage may identify a proportional amount that may be applied. The activity record type identifies a type of an activity record. The flat amount value may specify a fixed amount that may be used as a modification for an activity value.

In one embodiment, the activity record corresponds to a user identified in a user profile that includes an additional value field used to generate the activity report. The additional value field may identify a modification for an activity value that is specific to a particular user, which may be specific for a particular rule.

In one embodiment, processing the activity record to generate the activity report includes identifying activity records corresponding to a time period. In one embodiment, the time period may identify the dates for which work is completed and for which a modification for an activity value is provided.

Processing the activity record to generate the activity report may further include generating the activity report with multiple job values corresponding to job records from the activity records and with an activity value corresponding to a set of activity records consolidated from the activity records. The activity value is set to a value of zero when determined to be a negative number from the set of activity records for the time period.

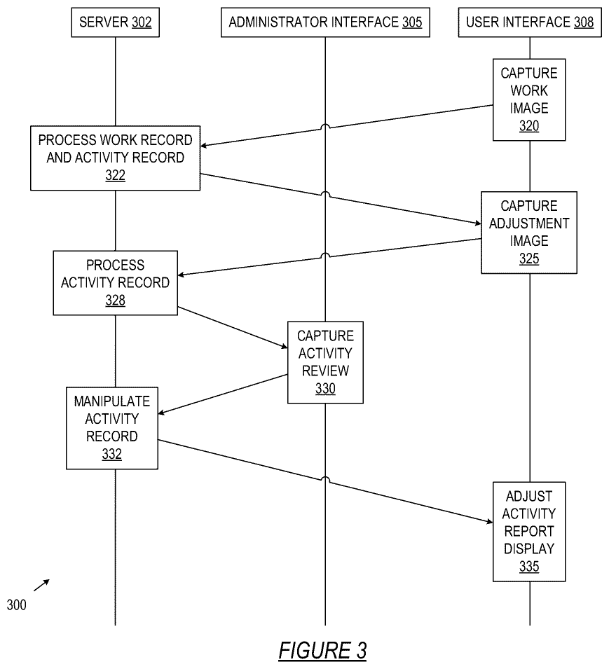

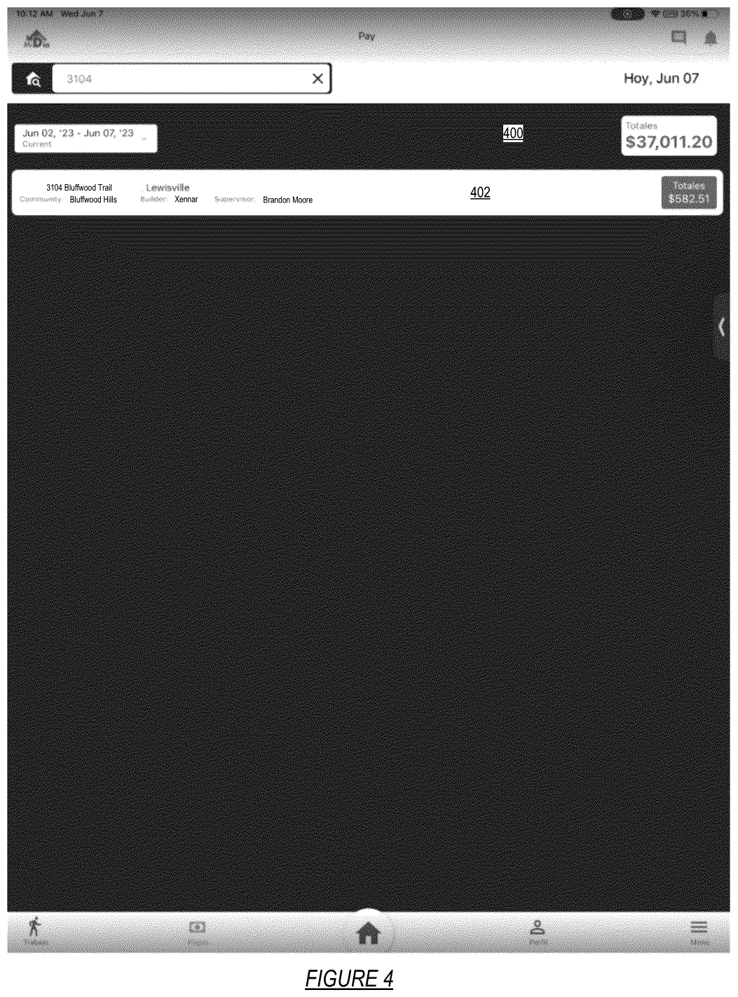

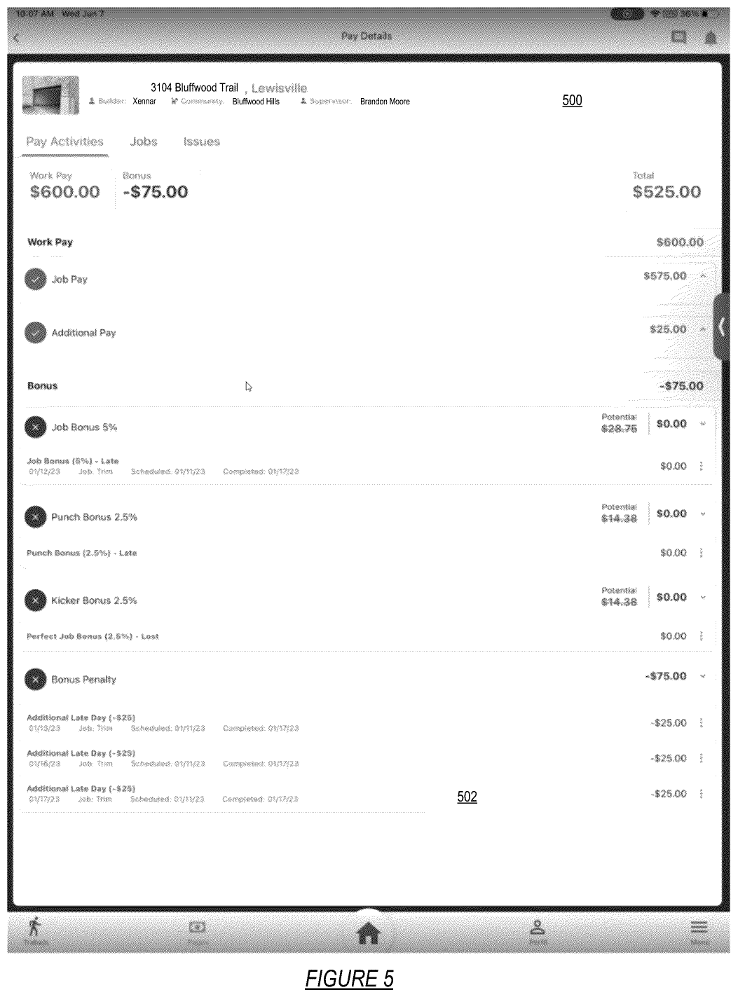

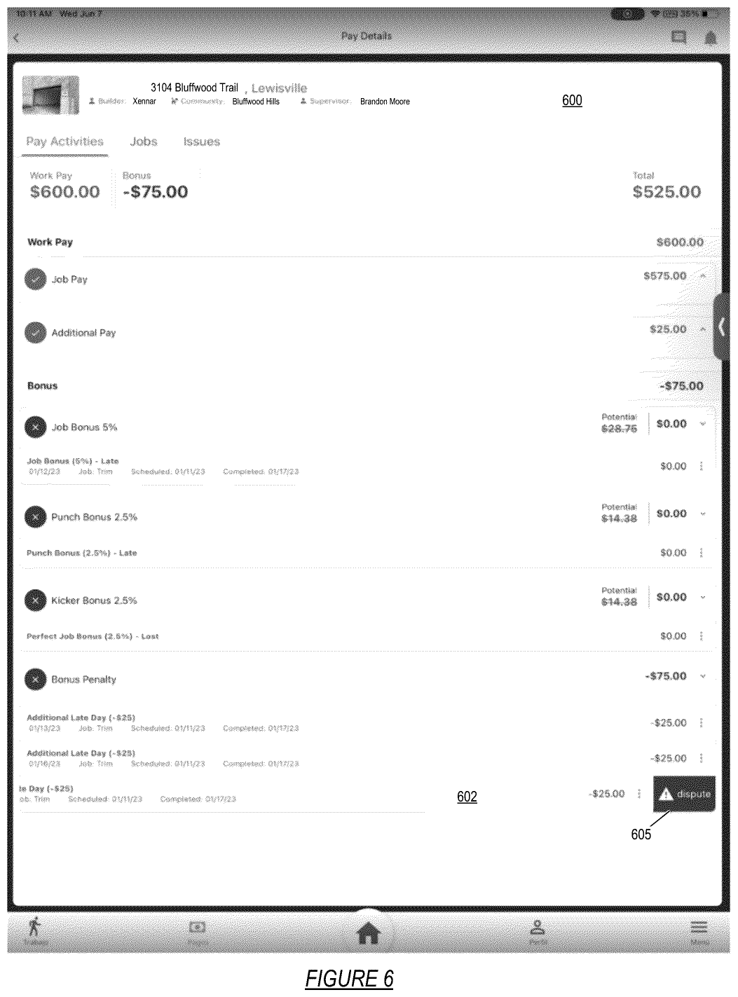

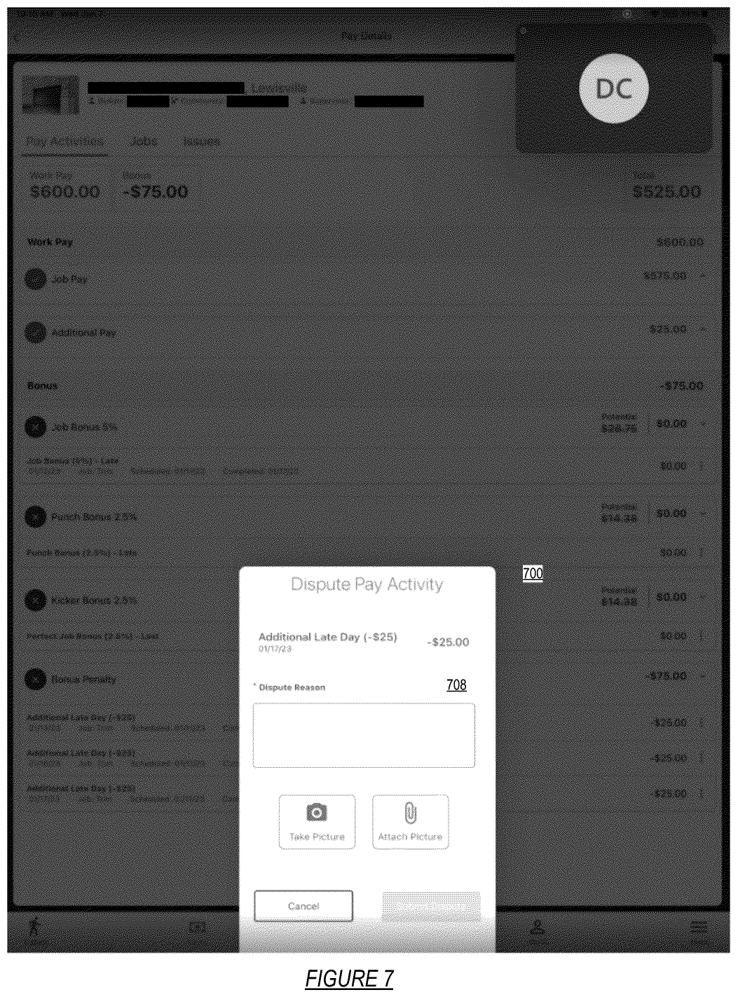

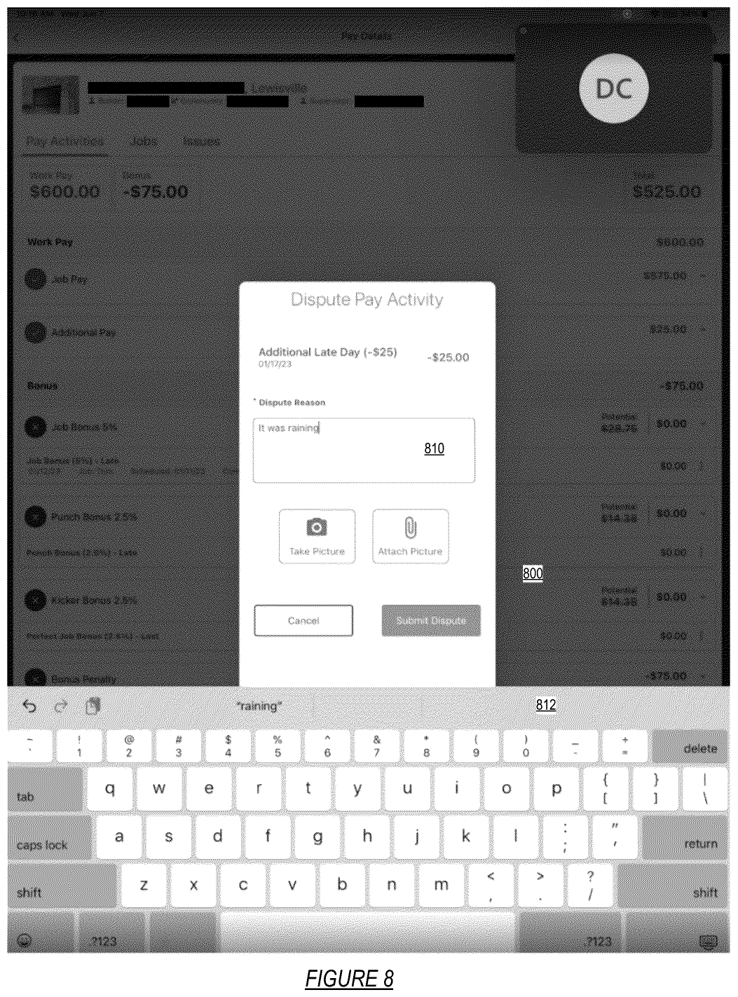

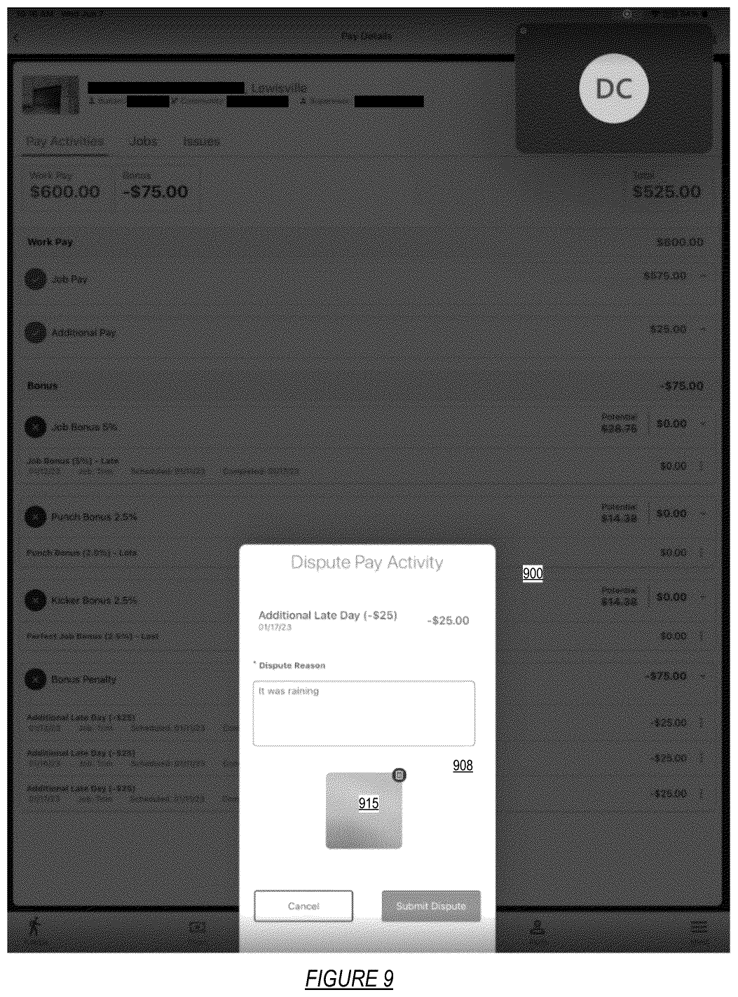

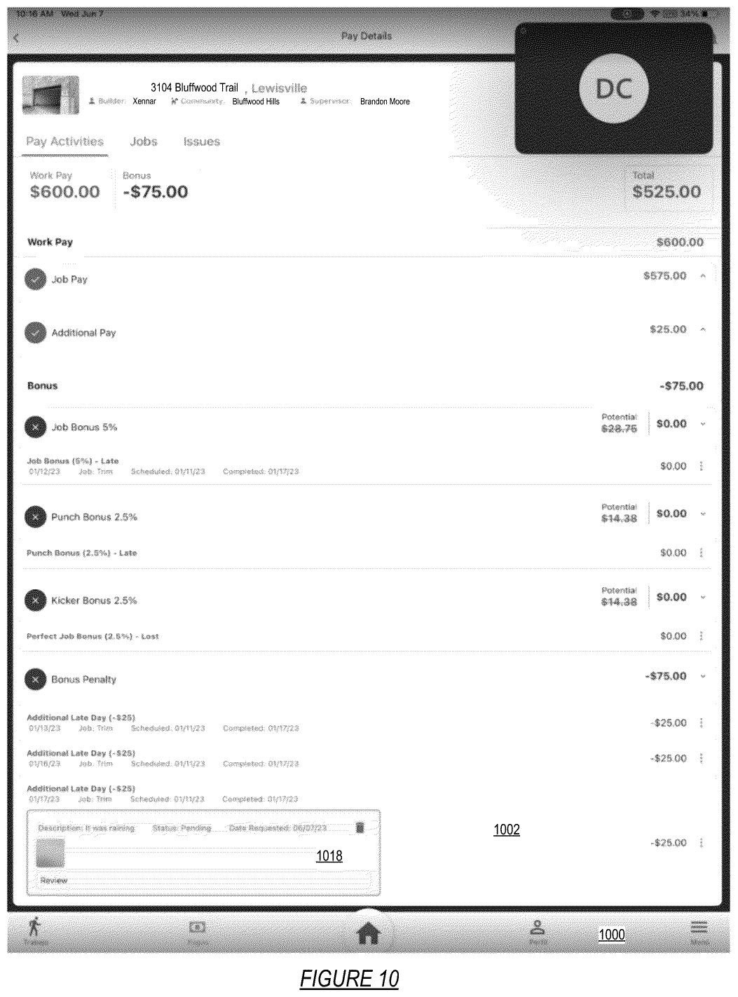

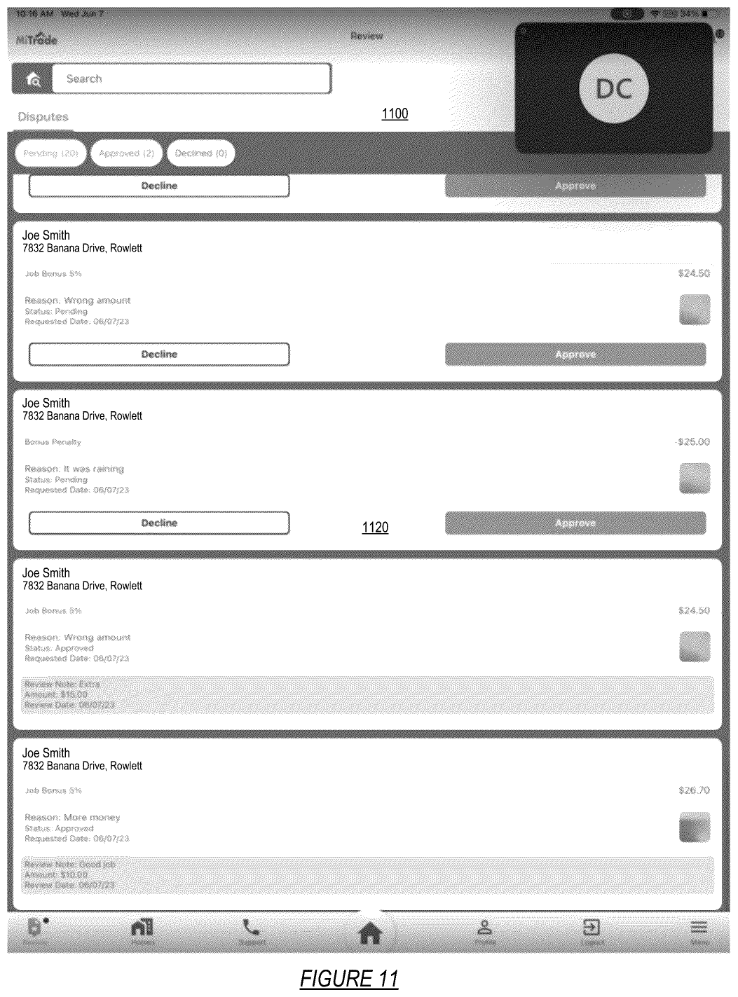

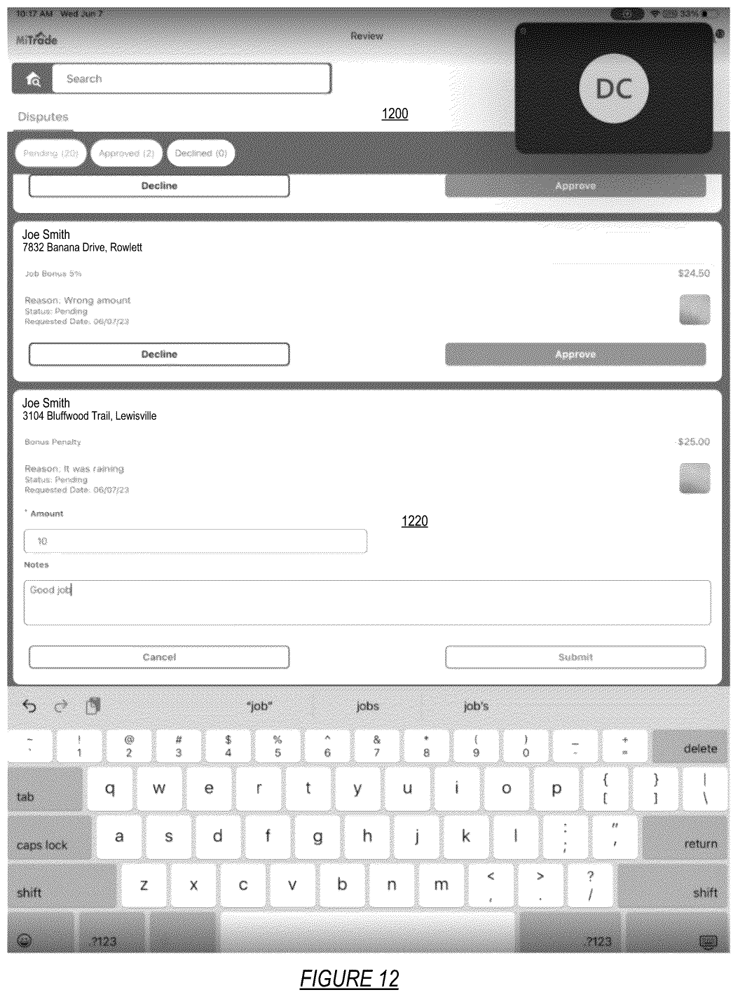

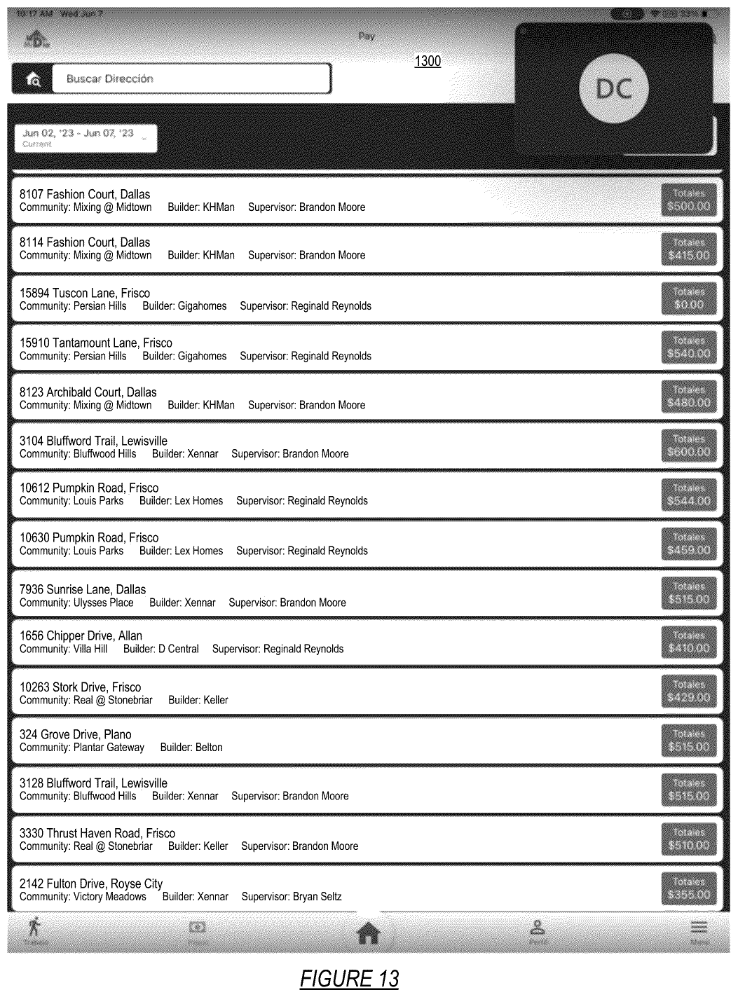

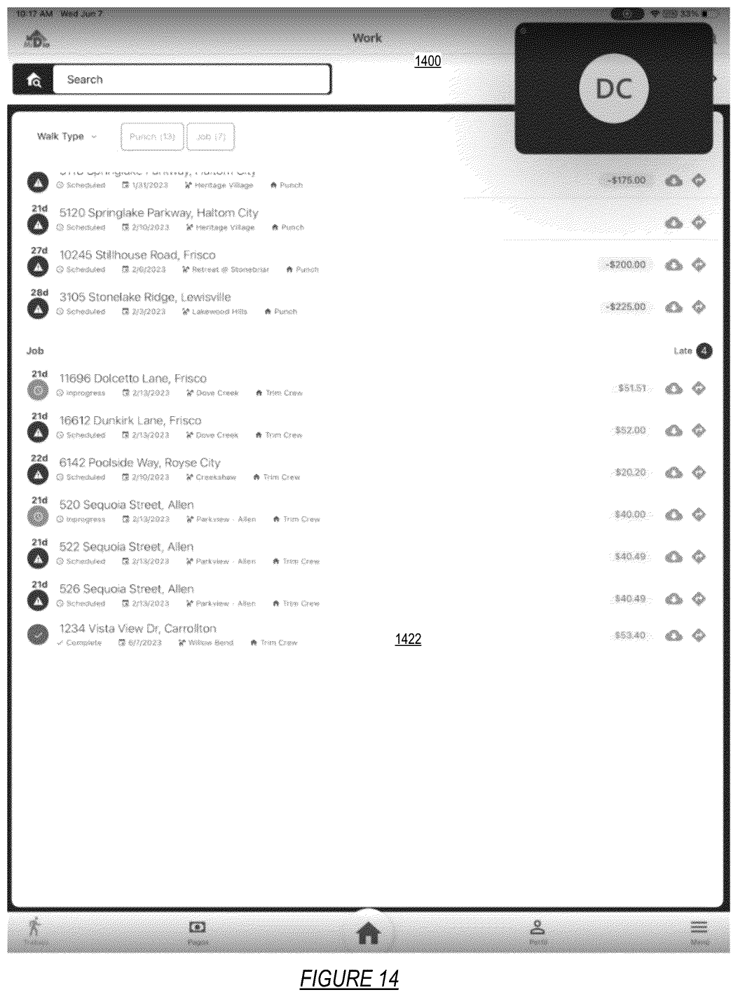

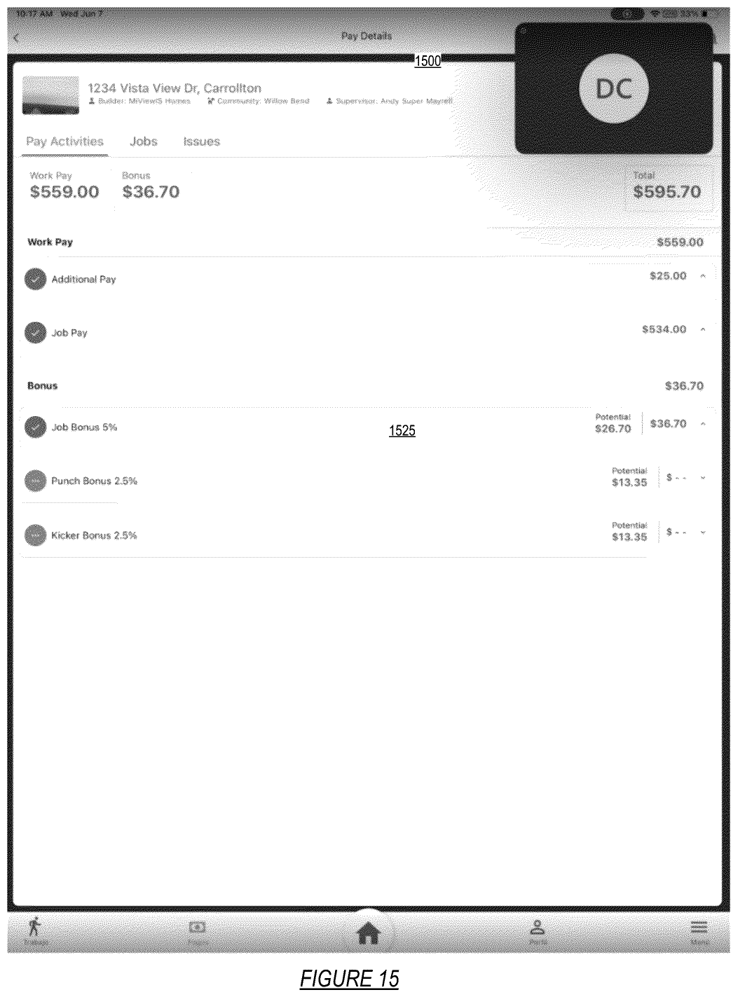

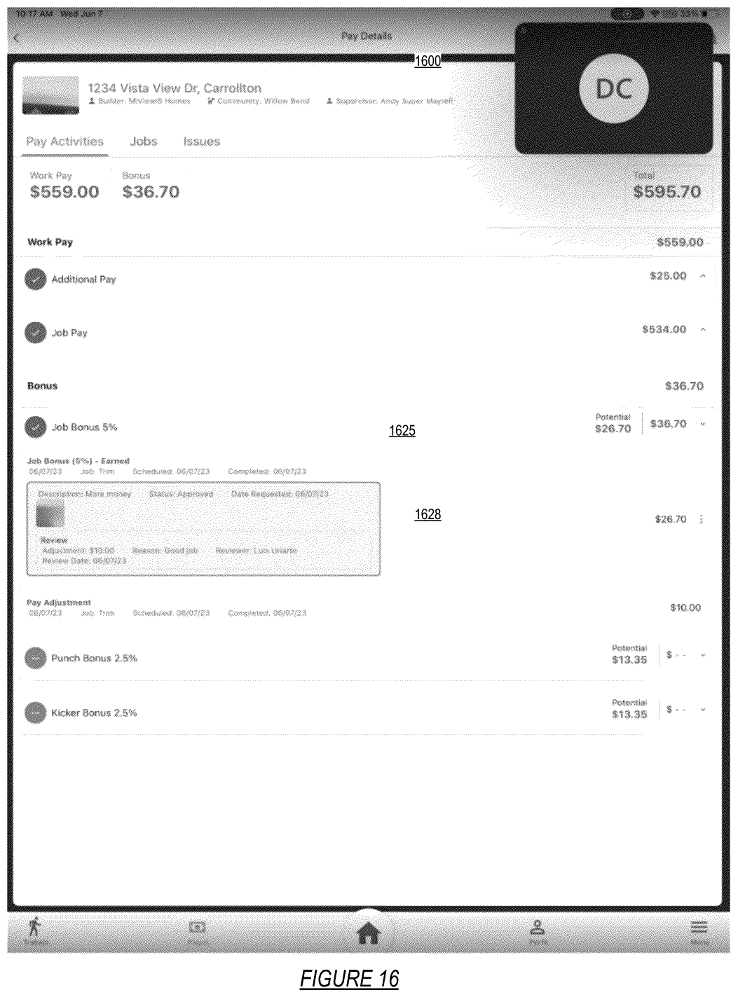

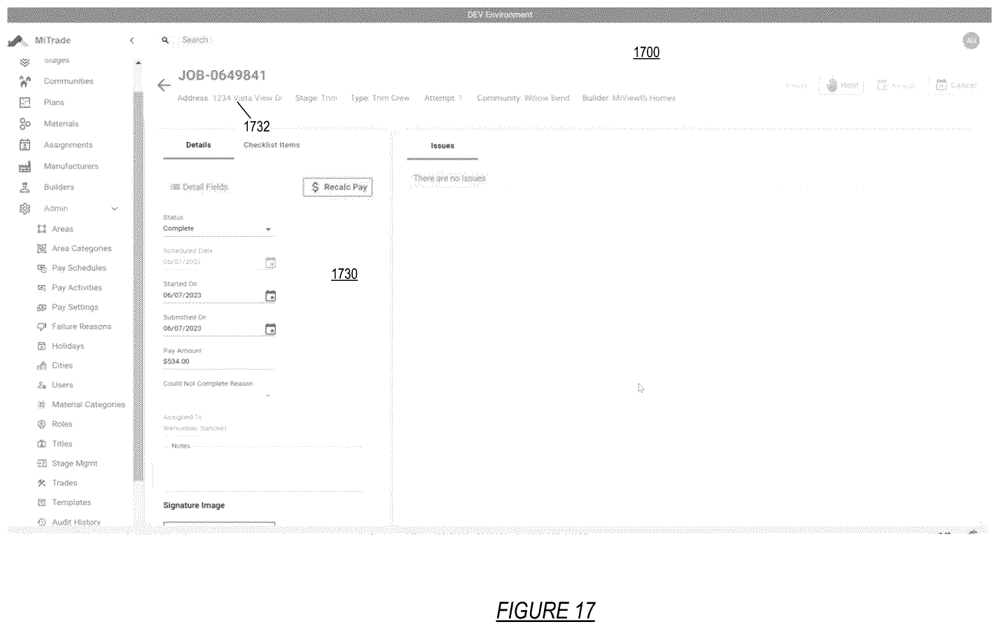

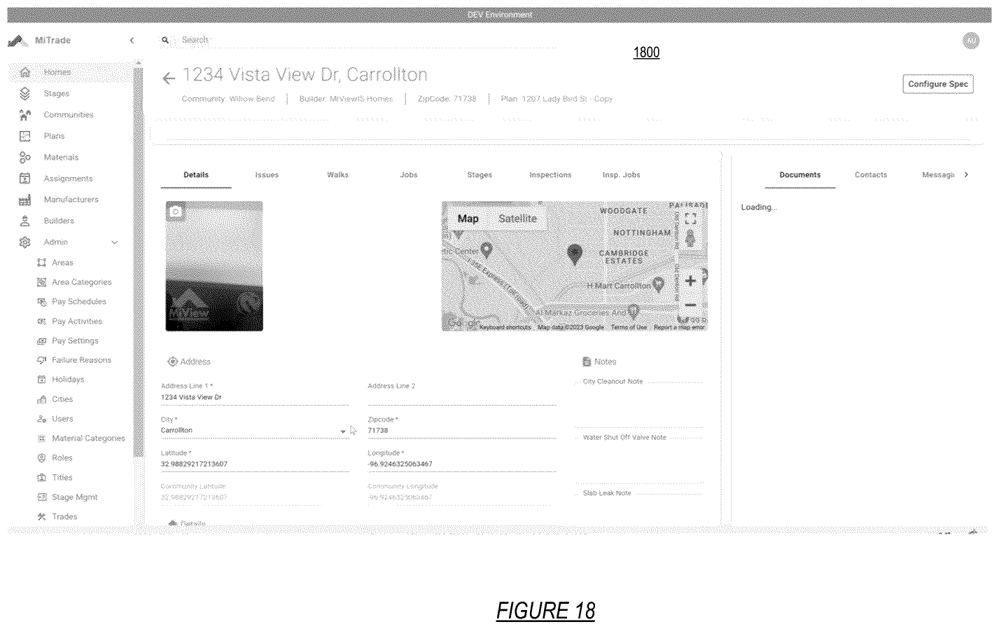

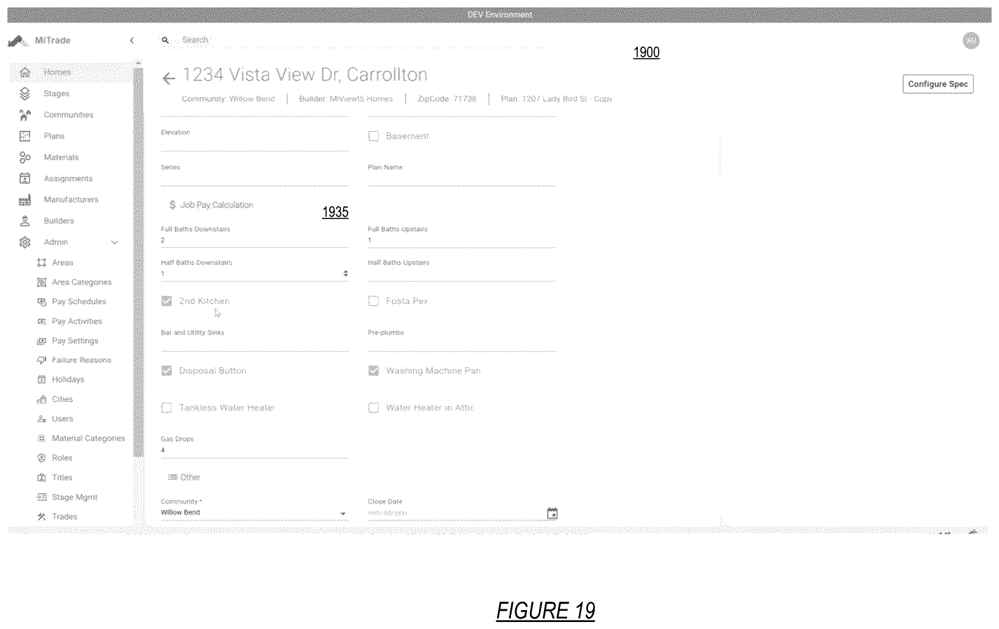

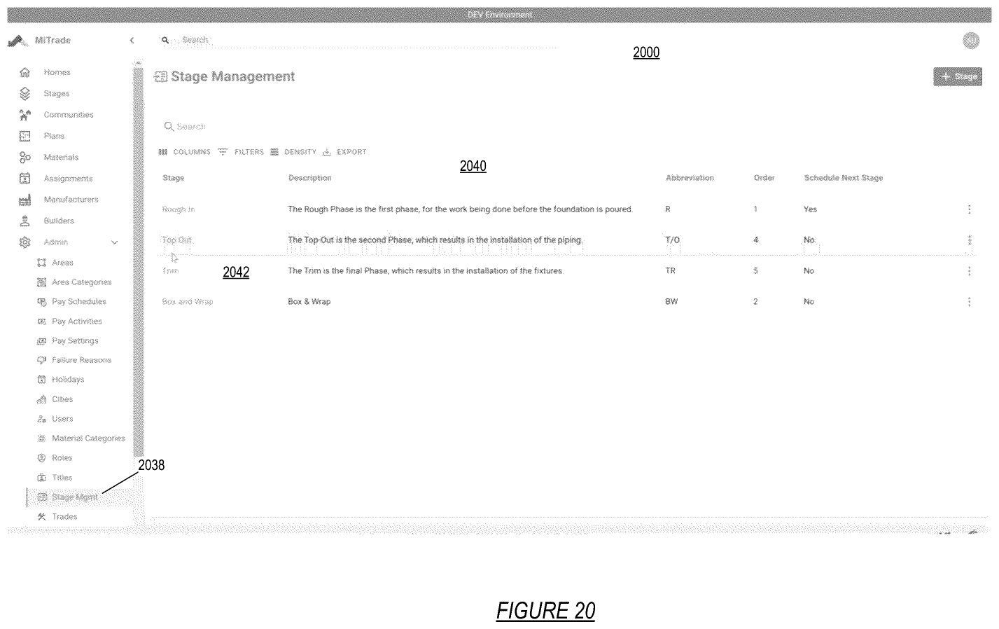

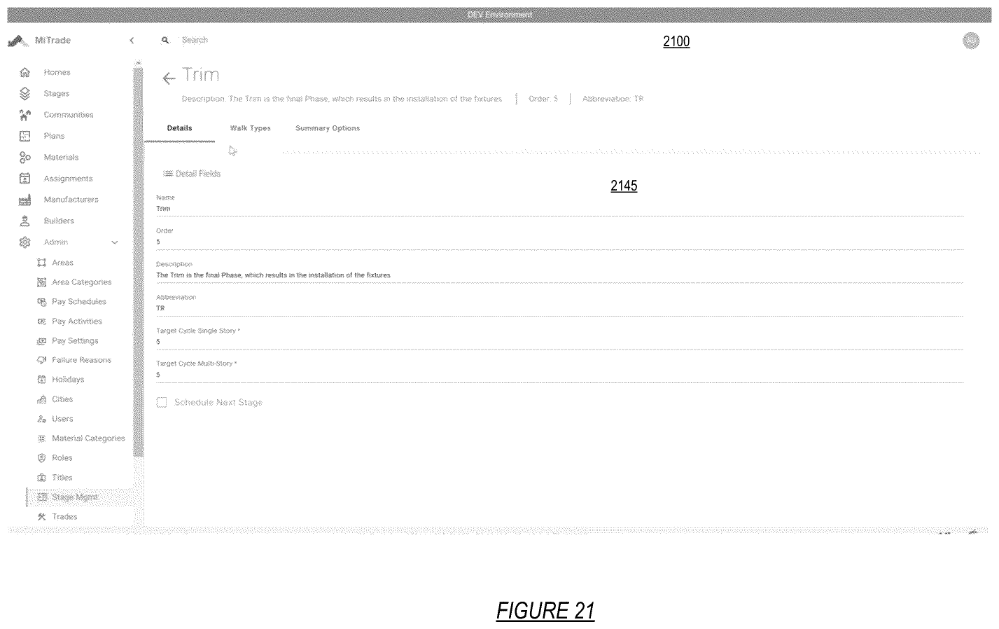

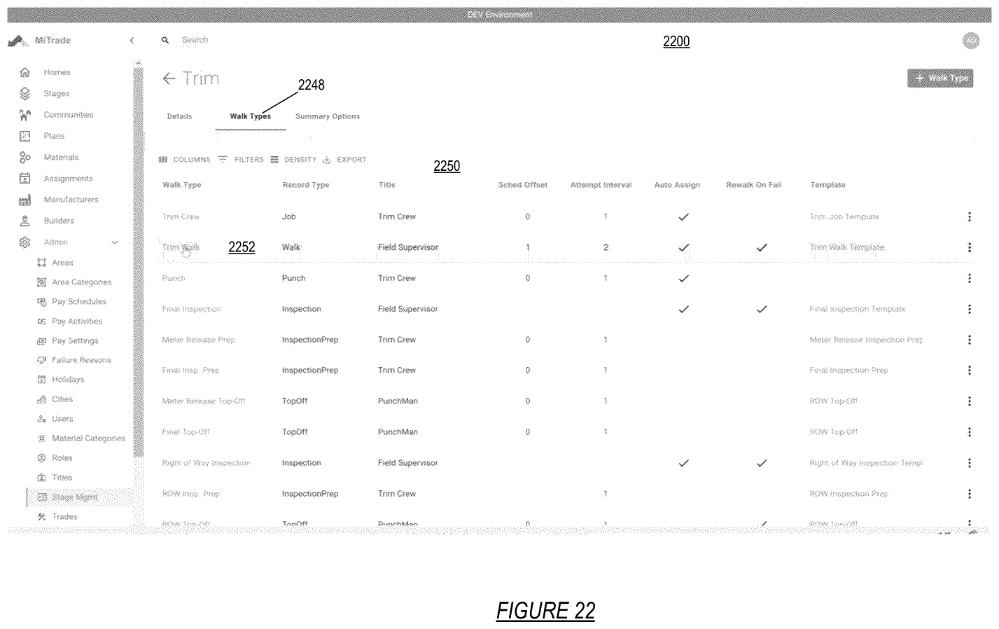

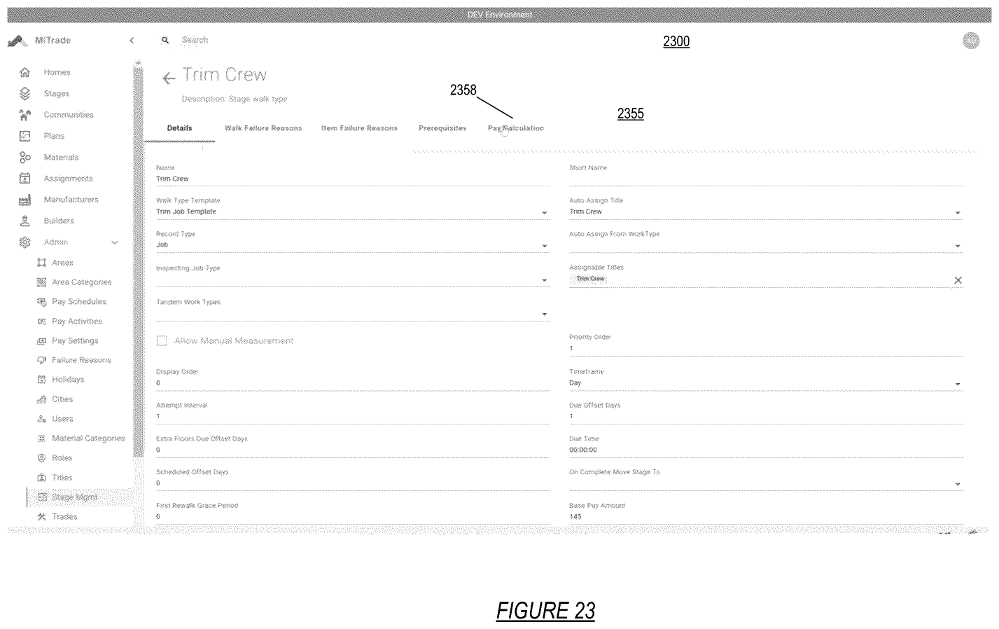

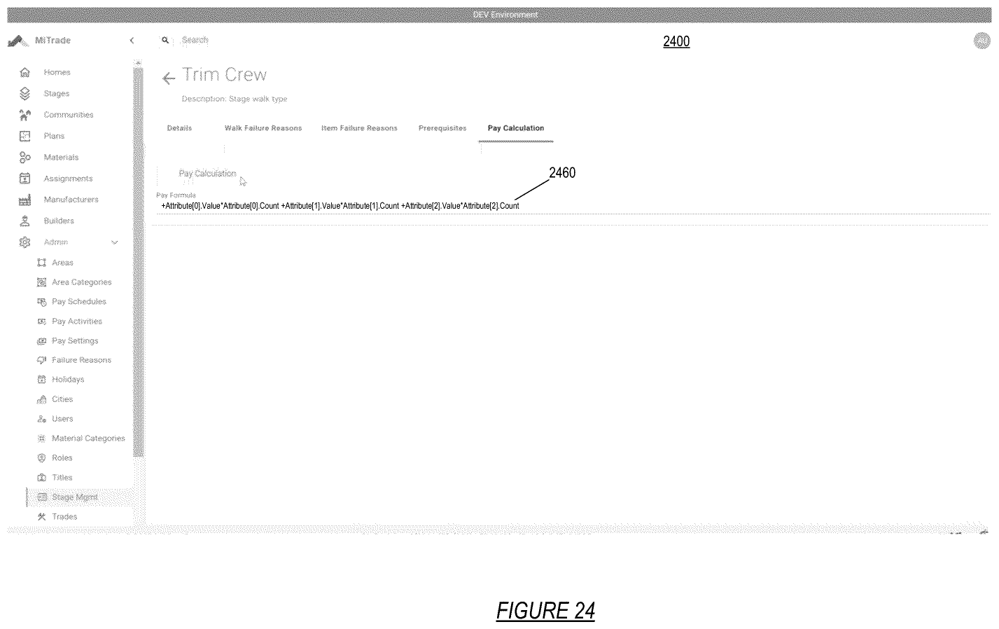

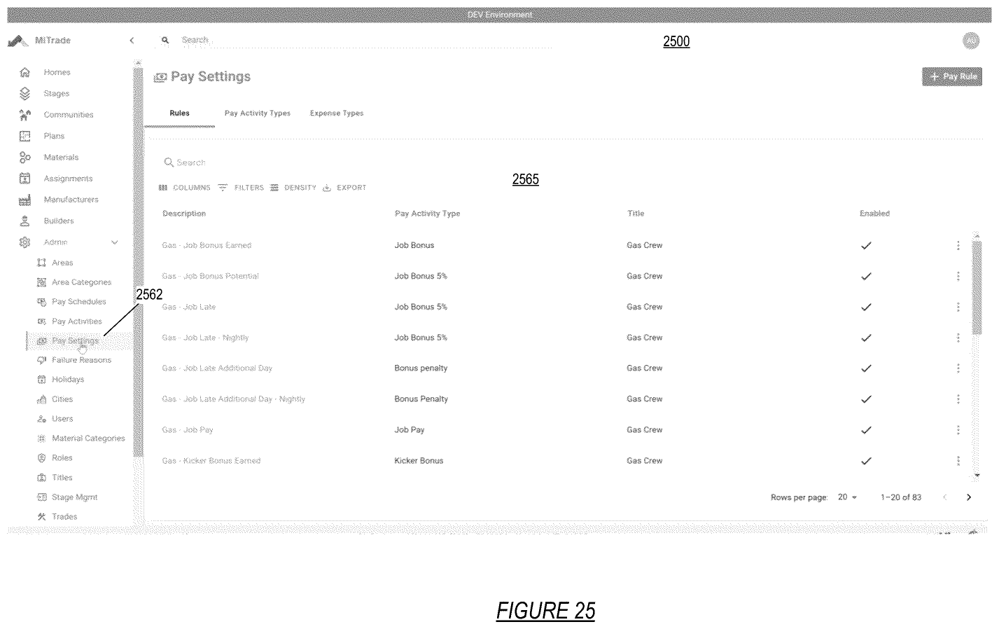

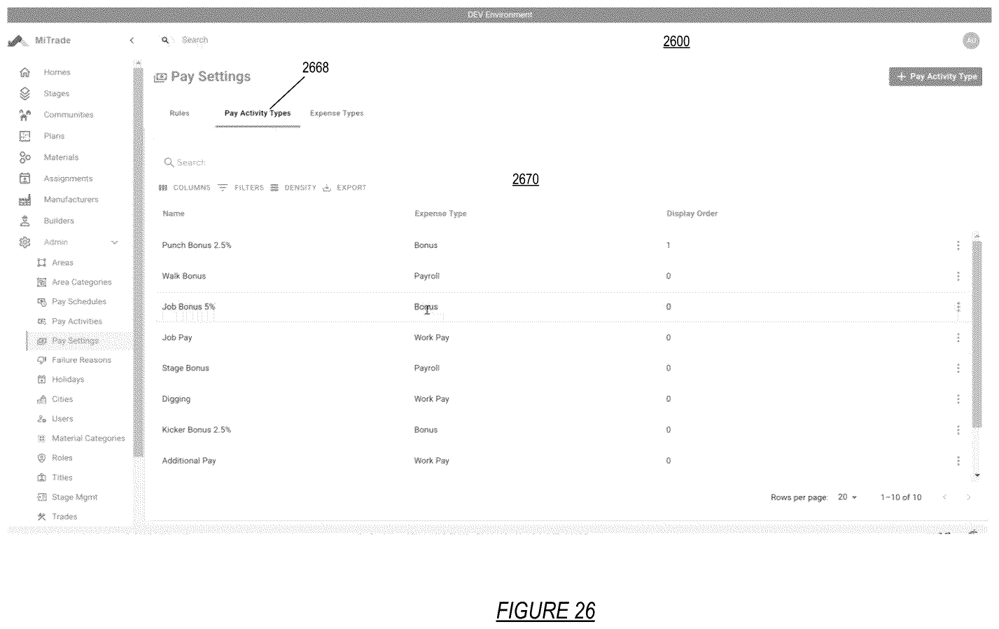

Turning to FIG. 3, the sequence (300) illustrates adjustment to the user interface (308) from processing messages, records, and reports. The sequence (300) may be performed with the server (302), the administrator interface (305), and the user interface (308). The server (302) may be a server as described in FIG. 1 and a computing system as described in FIGS. 43A and 43B. The administrator interface (305) may be a graphical user interface that is displayed on a device operated by an administrator. The user interface (308) may be a graphical user interface that is displayed on a user device (e.g., a worker device or a trade device) operated by a user that may be a worker (which may be referred to as a worker interface on a worker device) or a supervisor of the worker (which may be referred to as a trade interface on a trade device).

At Block 320, a work image is captured with the user interface (308). The work image documents the state of a worksite and is transmitted to the server (302) in a work message.

At Block 322, a work record and an activity record are processed. The server (302) receives the work message from the user interface (308) and extracts work information from the work message. The work information may be stored to the work record. After determining that the work record is updated, which may be done periodically or in real time, the activity record is updated in accordance with a rule that identifies a trigger event corresponding to the work record and defining the activity record. After generating the activity record, the server (302) may generate an activity report, which may be transmitted to and displayed by the user interface (308).

At Block 325, after displaying information from the activity report, the user operating the user interface (308) may dispute the activity record and request an adjustment with an adjustment message that is transmitted to the server (302). The adjustment message includes adjustment information, which may include an adjustment image that documents the state of the worksite.

At Block 328, responsive to receiving an adjustment message from the user interface (308), the server (302) processes the activity record to include adjustment information from the adjustment message. After updating the activity record with the adjustment information, the server (302) may generate another report (referred to as an adjustment report) that is transmitted to the administrator interface (305).

At Block 330, the administrator interface (305) captures an activity review. The administrator operating the administrator interface (305) reviews information from the adjustment report and accepts or denies the request to adjust the activity record. The review may be performed automatically or by a person logged in as an administrator. Resolution of the request is transmitted in a message (e.g., a resolution message) sent back to the server (302).

At Block 332, the activity record is manipulated. Manipulation of the activity record is responsive to the resolution message received from the administrator interface (305). The activity value of the activity record may be adjusted (e.g., a penalty amount may be set to zero) and the presentation of the activity value may be updated. For example, the negative value has been displayed using a red color with a larger font and, after being set to zero, it's displayed with a black color with a smaller font. Different types of adjustments may be made. Adjustments to the activity record may be stored in an activity report that is transmitted to the user interface (308).

At Block 335, the user interface (308) adjusts the display of the activity report. The user interface (308) may adjust the font color, font size, layout, etc., of the display of the information from the activity report.

Turning to FIG. 4, the user interface (400) is displayed on a user device with user interface elements using multiple sizes, colors, and styles. The user interface (400) may be displayed on a worker device operated by a worker. The user interface (400) displays a list view adjusted to show the list item (402). The list item (402) shows information from an activity report for a worksite located at the address identified as “3104 Bluffwood Trail, Lewisville”. The information further identifies a name of the community (e.g., “Bluffwood Hills”) in which the worksite is located, a name of the builder (e.g., “Xennar”) that is developing the community, and a name of a supervisor (e.g., “Brandon Moore”) that supervises the worker operating the user interface (400). The list item (402) includes an activity value (e.g., “582.51”) for the work performed at the worksite identified by the list item (402) by the user of the user interface (400). The user interface (400) also includes a total activity value (e.g., “37,011.20”) for the time period identified as “Jun 02, '23-Jun 07,′23”.

Turning to FIG. 5, the user interface (500) is displayed on a user device. The user interface (500) is displayed after selection of the list item (402) from FIG. 4. The user interface (500) shows several line items that roll up into a total activity value (e.g., “525.00”). The line items displayed in the user interface (500) may correspond to different rules evaluated in response to different trigger events.

Multiple activity values are displayed, including the total value, pay value, and bonus value, along with additional line items for the displayed activity values. The total value (“525.00”) is displayed in green and is the sum of the work pay value (“600.00”) and the bonus value (“−75.00”). The work pay value (“600.00”) includes the job pay value (“575.00”) for performing the work at the worksite and the additional pay value (“25.00”) that is defined for the specific user of the user interface (500).

The bonus value (“−75.00”) is displayed in red and includes activity values from multiple rules applied to the work records for the worksite identified by the user interface (500). The bonus value (“−75.00”) is rolled up from the “job bonus 5%” value (“0.00”), the “punch bonus 2.5%” value (“0.00”), the “kicker bonus 2.5%” value (“0.00”), and the bonus penalty value (“−75.00”).

The “job bonus 5%” value (“0.00”) is defined by a rule that generates the “job bonus 5%” value responsive to determining that the work item (also referred to as the job) was performed on time. The potential value (“28.75”) for the “job bonus 5%” value (“0.00”) identifies the value that may accrue when the work item is performed on time. The potential value (“28.75”) is shown stricken out to indicate that the work item was not performed on time. The potential value (“28.75”) is 5% of the job pay value (“575.00”). The line item for the “job bonus 5%” value (“0.00”) includes information identifying the date the work was started (“01/12/23”), the type of work (“Job: Trim”), the date the work was scheduled for completion (“01/11/23”), and the date the work was completed (“01/17/23”).

The “punch bonus 2.5%” value (“0.00”) is defined by a rule that generates the “punch bonus 2.5%” value responsive to determining that the work item was performed on time. The potential value (“14.38”) for the “punch bonus 2.5%” value (“0.00”) identifies the value that may accrue when additional work for punch list items is completed. The punch list items may identify errors in the work performed that are to be corrected in order for the work to be completed. The potential value (“14.38”) is shown stricken out to indicate that the work for the punch list items was not completed on time (e.g., was not completed before the original completion date scheduled for the work at the worksite).

The “kicker bonus 2.5%” value (“0.00”) is defined by a rule that generates the “kicker bonus 2.5%” value responsive to determining that the work item was performed with no punch list items. When work is performed on time with no errors (e.g., no punch list items are identified), the “job bonus 5%” value, the “punch bonus 2.5%” value, and the “kicker bonus 2.5%” value may each accumulate to an account of the user. Here, punch list items were identified, and the work was not completed on time so the “kicker bonus 2.5%” value is set to zero.

The “bonus penalty” value (“−75.00”) is defined by a rule that generates the “bonus penalty” value. The rule for the “bonus penalty” value may increase the penalty amount for each day that the work item is identified as late. Here, dates for the days late include “01/13/23”, “01/16/23”, and “01/17/23”. Dates for the days “01/14/23” and “01/15/23” are not included since those days correspond to a Saturday or Sunday (or a holiday). The date “01/17/23” is shown in the user interface element (502) as a list item of a list for the “Bonus Penalty”.

Turning to FIG. 6, the user interface (600) is displayed on a user device. The user interface (600) is displayed after manipulation of the user interface element (502) of FIG. 5. The user interface element (502) of FIG. 5 may be selected or dragged to the left as shown by the user interface element (602) of FIG. 6. The user interface element (602) includes the dispute button (605). Selection of the dispute button (605) allows a user to request an adjustment to (e.g., “dispute”) a line item of the “bonus penalty” list.

Turning to FIG. 7, the user interface (700) is displayed on a user device. The user interface (700) is displayed after selection of the dispute button (605) of FIG. 6 to display the view (708) in the user interface (700). The view (708) captures information about the adjustment request, which may include a textual description (“Dispute Reason”) and an image (referred to as an adjustment image). The adjustment image may be captured by the user device or be selected from images stored on the user device.

Turning to FIG. 8, the user interface (800) is displayed on a user device. The user interface (800) is displayed after selection of the edit box (810) to provide a textual description (“Dispute Reason”) for the adjustment request. Upon selection of the edit box (810), the keyboard (812) is displayed to capture the textual description (e.g., “It was raining”).

Turning to FIG. 9, the user interface (900) is displayed on a user device. The user interface (900) includes the view (908) and is displayed after capturing or selecting an adjustment image. The adjustment image is transformed to generate a thumbnail image for the icon (915). The icon (915) further includes a deletion icon layered on top of the thumbnail image. Selection of the deletion icon will delete the image from the adjustment request.

Turning to FIG. 10, the user interface (1000) is displayed on a user device. The user interface (1000) is displayed after saving an adjustment request. The adjustment request may be saved by selecting a submit button from the view (908) from FIG. 9, which may transmit an adjustment message that includes the additional request to a server. After processing by the server, the user interface element (1002) is updated to include the user interface element (1018). The user interface element (1018) includes details about the adjustment request, including a thumbnail image for an adjustment image, which may document the state or status of the worksite.

Turning to FIG. 11, the user interface (1100) is displayed on a user device with user interface elements using multiple sizes, colors, and styles. The user interface (1100) may be displayed on an administrator device. In one embodiment, the administrator device is a trade device displaying a trade interface operated by a supervisor of a worker. The user interface (1100) displays multiple adjustment requests in a list, which includes the interface element (1120). The interface element (1120) displays work information and activity information from the work records and activity records related to an adjustment request. The work information identifies the worker and location of the worksite. The activity information identifies the type of activity (“bonus penalty”), activity value (“−25.00”), and adjustment information. The adjustment information includes a textual description and includes a thumbnail of an image that may document the status of the worksite related to the adjustment request. The thumbnail may be selected to show the adjustment image. The decline and approve buttons may be used to decline or approve the adjustment.

Turning to FIG. 12, the user interface (1200) displayed on a user device. Responsive to selecting the approve button from the interface element (1120) of FIG. 11, the view of the interface element (1220) is expanded to include additional user interface elements. The view is expanded to identify an amount value for the adjustment and to provide a textual description (“good job”) for approval of the adjustment request.

Turning to FIG. 13, the user interface (1300) is displayed on a user device with user interface elements using multiple sizes, colors, and styles. The user interface (1300) may be displayed on a worker device operated by a worker. The user interface (1300) displays a list view adjusted to show a scrollable activity list of items with activity values for work items performed at worksites for a time period.

Turning to FIG. 14, the user interface (1400) is displayed on a user device with user interface elements using multiple sizes, colors, and styles. The user interface (1400) may be displayed on a worker device operated by a worker. The user interface (1400) displays a list view adjusted to show a scrollable job list of items that display activity values for work items performed at worksites. For example, the job list includes the work item (1422). The work item (1422) displays work information and activity information. The work information includes a location of the worksite, and the activity information includes a real-time activity value. The real-time activity value indicates the activity value that will accrue if the work identified by the work item (1422) is completed “today”, which is the day that the user interface (1400) is displayed to the worker.

Turning to FIG. 15, the user interface (1500) is displayed on a user device. The user interface (1500) may be displayed after selection of the work item (1422) of FIG. 14. The user interface (1500) displays a list with activity values related to the worksite located at an address (“1234 Vista View Dr, Carrollton”). The list includes the item (1525) identified as “job bonus 5%”. The item identified as “job bonus 5%” has an activity value (“36.70”) that is greater than a potential value (“26.70”).

Turning to FIG. 16, the user interface (1600) is displayed on a user device. The user interface (1600) is displayed after selection of the item (1525) of FIG. 15. The item (1625) is modified to be expanded to show an additional adjustment value that has been added. The adjustment value (“10.00”) is added to the “job bonus 5%” value (“26.70”) to create a total value (“36.70”) for the item (1625). The adjustment value (“10.00”) was recorded by the system as part of an adjustment request received by the system. The adjustment request includes a thumbnail of an adjustment image that may be selected to display the adjustment image.

Turning to FIG. 17, the user interface (1700) is displayed on a user device. The user device may be an administrator device operated by an administrator. The user interface (1700) includes the view (1730). The view (1730) displays information from an activity record for a work item (which may be referred to as a “job”) for a worksite. The work item is identified with an identifier (“JOB-0649841”). The view (1730) displays an activity value (e.g., the “Pay Amount” value (“534.00”)) and dates related to the job. The information displayed in the user interface (1700) may be updated by the user. The user interface (1700) includes links to other views, including the link (1732).

Turning to FIG. 18, the user interface (1800) is displayed on a user device. The user interface (1800) is displayed responsive to selecting the link (1732) from FIG. 17. The user interface (1800) provides additional information about the worksite in an adjustable view.

Turning to FIG. 19, the user interface (1900) is displayed on a user device. The user interface (1900) is updated from the user interface (1800) of FIG. 18 by scrolling down to display the section (1935) named “Job Pay Calculation”. The section (1935) includes information that may be stored in work records and activity records and used by rules to generate activity records from work records. For example, the number of full and half baths may identify the number of areas of a worksite. In one embodiment, worksites with more areas may allow for a threshold number of punch list items before assessing penalties related to functionalist items.

Turning to FIG. 20, the user interface (2000) is displayed on a user device. The user interface (2000) is displayed after selecting the link (2038) (named “Stage Mgmt”). The user interface (2000) displays the list (2040). The list (2040) enumerates different stages for a worksite. The different stages may be associated with different work items and jobs, which may be assigned to different workers. The list (2040) includes the list item (2042) named “Trim” for a trim stage.

Turning to FIG. 21, the user interface (2100) is displayed on a user device. The user interface (2100) is displayed after selecting the item (2042) from FIG. 20. The user interface (2100) displays the view (2145), which displays information about the stage named “Trim”. The view (2145) includes multiple tabs named “Details”, “Walk Types”, and “Summary Options”.

Turning to FIG. 22, the user interface (2200) is displayed on a user device. The user interface (2200) is displayed after selecting the tab (2248) named “Walk Types”. The user interface (2200) displays the list (2250) with rows and columns with information about types of walks that may be performed at a worksite. The list (2250) includes the list item (2252) named “Trim Walk”.

Turning to FIG. 23, the user interface (2300) is displayed on a user device. The user interface (2300) is displayed after selecting the list item (2252) from FIG. 22. The user interface (2300) includes the view (2355), which displays information about the “walk type” named “Trim Crew”. The view (2355) includes the link (2358) named “pay calculation”.

Turning to FIG. 24, the user interface (2400) is displayed on a user device. The user interface (2400) is displayed after selecting the link (2358) of FIG. 23. The user interface (2400) displays a calculation that includes the formula (2460). The formula (2460) includes the elements listed below.

+Attribute[0]·Value*(Attribute[0]·Count)

+Attribute[1]·Value*(Attribute[1]·Count)+

Attribute[2]·Value*(Attribute[2]·Count)

A data structure (“Attribute”) includes values and counts. The values of an attribute are multiplied by the count of the attribute to generate a set of products that are summed together. As an example, an attribute may be “Full Baths Downstairs” (which may correspond to an element from the section (1935) from FIG. 19), which has a count of “2” and for which the value may be set to “80”. With these parameters, the total value for the “Full Baths Downstairs” attribute would be “160”. Multiple attributes may have their values and counts included in a calculation for a work item and for a worksite to generate an activity value for the work performed. For example, the formula may be used to calculate the activity value named “job pay” (see, e.g., FIG. 5 showing a “job pay” activity value of “575.00”).

Turning to FIG. 25, the user interface (2500) is displayed on a user device. The user interface (2500) is displayed after selecting the link (2562) named “pay settings”. The user interface (2500) displays the list (2565). The list (2565) displays a list of rules from which activity records are generated.

Turning to FIG. 26, the user interface (2600) is displayed on a user device. The user interface (2600) is displayed after selecting the link (2668) named “Pay Activity Types”. The user interface (2600) displays the list (2670). The list (2670) displays a list of types of activity records that may be generated.

Turning to FIG. 27, the user interface (2700) is displayed on a user device. The user interface (2700) is displayed after selecting the link (2772) named “Expense Types”. The user interface (2700) displays the list (2775). The list (2775) displays a list of types of accounting expenses for the activity values for the activity records generated with the rules from the list (2565) of FIG. 25.

Turning to FIG. 28, the user interface (2800) is displayed on a user device. The user interface (2800) is displayed after selecting the link (2878) named “Rules” and is updated from the user interface (2500)) of FIG. 25 after selection of the element (2880), which displays the menu (2882). The menu (2882) displays several elements for grouping, sorting, and filtering the items within the list (2865), including the element (2885) named “Group by Title”.

Turning to FIG. 29, the user interface (2900) is displayed on a user device. The user interface (2900) is displayed after selecting the element (2885) named “Group by Title” from FIG. 28. The list (2965) is updated (after selecting the element (2885) named “Group by Title” from FIG. 28) to show the rules organized into groups. The list (2965) includes the list item (2988) named “Trim Crew”. The list item (2988) aggregates rules for work performed by a trim crew. The number (“(21)”) indicates that there are “21” rules in a group for the list item (2988).

Turning to FIG. 30, the user interface (3000) is displayed on a user device. The user interface (3000) is displayed after selecting the list item (2988) from the FIG. 29. The list item (3088) is updated to show a listing of the rules grouped into the list item (3088), which includes the item (3090) for the rule named “Trim-Job Pay” and the item (3091) for the rule named “Trim-Job Bonus Potential”, the item (3092) for the rule named “Trim-Job Bonus Earned”, and the item (3093) for the rule named “Trim-Job Late”.

Turning to FIG. 31, the user interface (3100) is displayed on a user device. The user interface (3100) is displayed after selecting the item (3090) from the FIG. 30. The view (3192) is a scrollable view that displays the rule attributes for the rule named “Trim-Job Pay”. The following rule attributes are included.

| Name | Value | Description |
|---|---|---|
| Description | Trim - Job | a textual description of the rule |
| | Bonus | |
| | Potential | |
| Display Text | Job Pay | the text to display for the rule for tool tips |
| | | and lists |
| Enabled | True | identifies if the rule is enabled for |
| | | processing |
| Can Be | False | identifies if a user of the system can |
| Disputed | | dispute activity records corresponding |
| | | to the rule |
| Pay Activity | Job Pay | identifies the type of activity; “Job Pay” is an |
| Type | | activity value accrued when a job is com- |
| | | pleted; a “bonus” type is accrued when |
| | | additional conditions are met |
| On Work | Create | identifies the action to perform when the |
| Event | | trigger event is detected; “Create” indicates |
| | | that an activity record will be created |
| Work Type | Trim Crew | identifies the type of work, which to a type |
| | (Trim) | of a work record |
| On Stage | (blank) | an optional trigger event to engage the rule |
| Status | | on a change to the status of a stage for a |
| | | worksite |
| Stage Type | (blank) | identifies a type of stage (also referred to as |
| | | a phase) for the worksite |
| Rule Identifier | Trim Job | identifies the type of the rule |
| | Pay Rule | |
| Payee Title | Trim Crew | identifies the type of user that can accrue |
| | | activity values (rewards, bonus, points, pay, |
| | | etc.) from the rule |
| Issue limit Per | (blank) | an optional numerical value that identifies the |
| Area | | number of issues (e.g., punch items) that may |
| | | occur with a work item before this rule is |
| | | applied; for example, value of “2” would |
| | | indicate that two punch list items may be |
| | | identified for the work item before the rule |
| | | is applied |
| Initial Status | payable | identifies the status of the activity value as |
| | | one of potential (may be accrued), pending |
| | | (has been accrued but is not yet payable), and |
| | | payable (has been accrued, is payable, and |
| | | may be included in payment for the current |
| | | time period) |
| Number of | (blank) | a numerical value that identifies the number |
| times to skip | | of times the rule may be skipped before the |
| before | | outcome of the rule is recorded; for example, |
| recording | | with a value of “3” for a late penalty, activity |
| | | values for late penalties may be accrued daily |
| | | but the first three late penalties will be |
| | | skipped so that a late penalty for the fourth |
| | | day late would be shown as the first late |
| | | penalty |
| Times to | 1 | identifies the upper limit for how many times |
| record per job | | an activity value from the rule may accrue for |
| | | a job; for example, a value of “1” for a late |
| | | penalty indicates that the late penalty for the |
| | | rule would accrue one time without accruing |
| | | a second or subsequent time |
| On condition | (blank) | identifies a condition for an activity value of |
| | | the rule to be accrued; for example, “job |
| | | completed on time” may identify that the job |
| | | is to be completed on time for the activity |
| | | value to be accrued |
| When job | (blank) | identifies a type of issue to be present for |
| includes issue | | the role to apply and the activity value to |
| type | | accrue |
| Amount ($) | (blank) | identifies an activity value as a specific |
| | | numerical value that is not proportional |
| | | to other values |
| Percent (%) | 100.00 | identifies the activity value for the rule as |
| | | a percentage of the “job pay” activity value |
| | | for the work performed |
| Percent of User | (blank) | identifies the activity value for the rule as |
| Additional Pay | | a percentage of the “additional pay” defined |
| (%) | | for the user |

Turning to FIG. 32, the user interface (3200) is displayed on a user device. The user interface (3200) is displayed after scrolling the list view (3292) down to show additional rule attributes. The following rule attributes are included.

| Name | Value | Description |
|---|---|---|
| Set Payable: | (blank) | identifies an optional trigger event, determined |
| On Stage | | from the stage status, to change the status of the |
| Status | | activity value of the rule to be set to payable |
| | | when the stage status is changed |
| Set Payable: | (blank) | identifies an optional trigger event to change the |
| Walk Type | | status of the activity value of the rule to be set to |
| Name | | payable when walk type identified by a walk |
| | | type name is performed |
| Set Payable: | (blank) | identifies an optional trigger event to change the |
| Walk Type | | status of the activity value of the rule to be set to |
| Event | | payable when walk type identified by a walk |
| | | type event is detected |
| Reference | (blank) | identifies a percentage of a reference activity value |
| Percent (%) | | from which to calculate the activity value for the |
| | | rule; the “Reference Percent (%)” used in |
| | | combination with the “Reference Rule Identifier” |
| | | and the ″Reference Pay Activity Type″ to |
| | | identify a proportional activity value that is |
| | | not based on the “job pay” activity value |
| Reference | (blank) | identifies the reference rule and corresponding |
| Rule | | reference activity value that is used with the |
| Identifier | | “Reference Percent (%)” to calculate the |
| | | activity value for the rule |
| Reference | (blank) | identifies the activity type for the rule when the |
| Pay Activity | | activity value for the rule is generated using a |
| Type | | reference rule |

Turning to FIG. 33, the user interface (3300) is displayed on a user device. The user interface (3300) is displayed after selecting the item (3091) from the FIG. 30. The view (3392) is a scrollable view that displays the rule attributes for the rule named “Trim-Job Bonus Potential”, which identifies a potential activity value for performance of work. The item (3395) displays a rule attribute to indicate the activity value for the rule is identified as five percent of the job pay activity value.

Turning to FIG. 34, the user interface (3400) is displayed on a user device. The user interface (3400) is displayed after selecting the item (3092) from the FIG. 30. The view (3492) is a scrollable view that displays the rule attributes for the rule named “Trim-Job Bonus Earned”, which identifies an activity value that is accrued and identified as earned in response to the user performing work at the worksite. The view (3492) shows the items (3401), (3402), and (3403), which indicate that a reference rule is used to identify the activity value for the rule of FIG. 34 (i.e., the rule named “Trim-Job Bonus Earned”).

Turning to FIG. 35, the user interface (3500) is displayed on a user device. The user interface (3500) is displayed after selecting the item (3093) from the FIG. 30. The view (3592) is a scrollable view that displays the rule attributes for the rule named “Trim-Job Late”, which identifies an activity value (a penalty value) that may be accrued when a work item for a worksite is completed late. The view (3592) includes the item (3506), which indicates that adjustment requests to dispute activity values generated from the rule “Trim-Job Late” may be disputed by users of the system.

Turning to FIG. 36, the user interface (3600) is displayed on a user device. The user interface (3600) is displayed after selecting the item (3609). The item (3609) corresponds to the rule attribute named “On Condition” and may have the values “Late” or “On Time”. The value “Late” indicates that the rule “Trim-Job Late” is applied when corresponding work is identified as being completed “Late”. The value “On Time” indicates that the rule “Trim-Job Late” is applied when corresponding work is identified as being completed “On Time”.

Turning to FIG. 37, the user interface (3700) is displayed on a user device. The user interface (3700) is displayed after selecting the item (3711). The item (3711) corresponds to the rule attribute named “When Job Includes Issue Type” and may have the values “Punch”, “External”, and “Internal”. The value “Punch” indicates that the issue identified with the work is a punch issue that may have been caused by the worker that performed the work. The value “External” indicates that the issue identified with the work is an external issue that may have been caused by a different organization or trade that also performed work at the worksite. The value “Internal” indicates that the issue identified with the work is an internal issue that may have been caused by the organization of which the worker is an employee.

Turning to FIG. 38, the user interface (3800) is displayed on a user device. The user interface (3800) is displayed after selecting the element (3813) and selecting a particular user. The user interface (3800) includes the views (3816), (3819), and (3821).

The view (3816) is an image view that includes an image of the user along with the name (“FIRSTNAME LASTNAME”) of the user. The image view also includes information to identify the type of user as “Trim Crew”, which indicates that the user is a worker that works as part of a crew that does trim jobs.

The view (3819) is a detailed view that includes information about the user, which includes the elements (3823), (3826), and (3829) to identify an amount for additional pay that may be received by the user for doing jobs as part of a trim crew. The element (3823) named “Additional Pay” identifies a numeric value for the additional pay. The element (3826) named “Additional Pay Description” provides a textual description that describes what the additional pay is for. The element (3829) named “Additional Pay Activity Type” identifies the activity type for the additional pay.

The view (3821) is a message view. The message view displays messages that have been sent between the system and the user.

Turning to FIG. 39, the user interface (3900) is displayed on a user device. The user interface (3900) is displayed after selecting the element (3929). Selection of the element (3929) displays a menu that displays the different types of activities that may be associated with the additional pay for the user. The activity types include “additional pay”, “Bonus Penalty”, “Digging”, “Job Bonus 5%”, “Job Pay”, and “Kicker Bonus 2.5%”.

Turning to FIG. 40, the user interface (4000) is displayed on a user device. The user interface (4000) is displayed after scrolling down inside of the menu displayed after selection of the element (4029). The activity types further include “Punch Bonus 2.5%”, “Stage Bonus”, “Stage Bonus Penalty”, and “Walk Bonus”.

Turning to FIG. 41, the user interface (4100) is displayed on a user device. The user interface (4100) is displayed after selection of the element (4131) named “Pay Activities”. Selecting the element (4131) displays the view (4133) with rows and columns. The view (4133) displays activity records generated by the rules maintained by the system. One row corresponds to one activity record and the columns include information corresponding to the activity record.

Turning to FIG. 42, the user interface (4200) is displayed on a user device. The user interface (4200) is displayed after selection of the element (4236) named “Pay Schedules”. Selecting the element (4236) displays a list of schedules from which the schedule displayed in the view (4239) is selected. The view (4239) includes rows to enumerate different time periods and columns to identify information for the time period. Each time period includes information of a “Start Date”, an “End Date”, and a “Pay Date”. The start date and end date identify the time period during which work items are to be completed to have activity values accrued on the pay date.

Embodiments of the disclosure may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 43A, the computing system (4300) may include one or more computer processors (4302), non-persistent storage device(s) (4304), persistent storage device(s) (4306), a communication interface (4312) (e.g., Bluetooth interface, infrared interface, network interface, optical interface, etc.), and numerous other elements and functionalities that implement the features and elements of the disclosure. The computer processor(s) (4302) may be an integrated circuit for processing instructions. The computer processor(s) may be one or more cores or micro-cores of a processor. The computer processor(s) (4302) includes one or more processors. The one or more processors may include a central processing unit (CPU), a graphics processing unit (GPU), a tensor processing (TPU), combinations thereof, etc.

The input devices (4310) may include a touchscreen, keyboard, mouse, microphone, touchpad, electronic pen, or any other type of input device. The input devices (4310) may receive inputs from a user that are responsive to data and messages presented by the output devices (4308). The inputs may include text input, audio input, video input, etc., which may be processed and transmitted by the computing system (4300) in accordance with the disclosure. The communication interface (4312) may include an integrated circuit for connecting the computing system (4300) to a network (not shown) (e.g., a local area network (LAN), a wide area network (WAN) such as the Internet, mobile network, or any other type of network) and/or to another device, such as another computing device.

Further, the output devices (4308) may include a display device, a printer, external storage, or any other output device. One or more of the output devices may be the same or different from the input device(s). The input and output device(s) may be locally or remotely connected to the computer processor(s) (4302). Many different types of computing systems exist, and the aforementioned input and output device(s) may take other forms. The output devices (4308) may display data and messages that are transmitted and received by the computing system (4300). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (4300) in FIG. 43A may be connected to or be a part of a network. For example, as shown in FIG. 43B, the network (4320) may include multiple nodes (e.g., node X (4322), node Y (4324)). Each node may correspond to a computing system, such as the computing system shown in FIG. 43A, or a group of nodes combined may correspond to the computing system shown in FIG. 43A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (4300) may be located at a remote location and connected to the other elements over a network.

The nodes (e.g., node X (4322), node Y (4324)) in the network (4320) may be configured to provide services for a client device (4326), including receiving requests and transmitting responses to the client device (4326). For example, the nodes may be part of a cloud computing system. The client device (4326) may be a computing system, such as the computing system shown in FIG. 43A. Further, the client device (4326) may include and/or perform all or a portion of one or more embodiments.

The computing system of FIG. 43A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user (e.g., data presented as actual data values through text) or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
extracting work information from a work message to adjust a work record;
manipulating an activity record responsive to the work record and a rule comprising a plurality of rule attributes to set an activity value of the activity record;
processing the activity record to generate an activity report comprising the activity value; and
adjusting a user interface responsive to the activity report.

2. The method of claim 1, wherein manipulating the activity record responsive to the rule comprises:
identifying a trigger event defined by the rule; and
setting the activity value defined by a plurality of rule attributes of the rule.

3. The method of claim 1, wherein manipulating the activity record responsive to the rule comprises:
extracting adjustment information from an adjustment message received responsive to a user interface display of the activity record; and
manipulating the activity record responsive to the adjustment information.

4. The method of claim 1, wherein adjustment information, extracted from an adjustment message received responsive to a user interface display of the activity record, comprises an adjustment image corresponding to the adjustment message.

5. The method of claim 1, wherein adjusting the user interface responsive to the activity report comprises:
modifying a list view displaying a plurality of activity records, comprising the activity record, by one or more of resizing the list view, adjusting a font size, and adjusting a font color responsive to the activity record.

6. The method of claim 1, wherein the plurality of rule attributes are set with an administrator device, and wherein the plurality of rule attributes comprises a work type, a work trigger event, an activity amount, and an activity percentage.

7. The method of claim 1, wherein the plurality of rule attributes comprises a rule attribute set with an administrator device, and wherein the rule attribute comprises an activity record type to identify a type of an activity record.

8. The method of claim 1, wherein the plurality of rule attributes comprises a rule attribute set with an administrator device, and wherein the rule attribute comprises a flat amount value.

9. The method of claim 1, wherein the activity record corresponds to a user identified in a user profile comprising an additional value field used to generate the activity report.

10. The method of claim 1, wherein processing the activity record to generate the activity report comprises:
identifying a plurality of activity records, comprising the activity record, corresponding to a time period; and
generating the activity report comprising a plurality of job values corresponding to a set of job records from the plurality of activity records and comprising an activity value corresponding to a set of activity records consolidated from the plurality of activity records, wherein the activity value is set to a value of zero when determined to be a negative number from the set of activity records for the time period.

11. A system comprising:
at least one processor;
an application, which when executed by the at least one processor:
extracts work information from a work message to adjust a work record;
manipulates an activity record responsive to the work record and a rule comprising a plurality of rule attributes to set an activity value of the activity record;
processes the activity record to generate an activity report comprising the activity value; and
adjusts a user interface responsive to the activity report.

12. The system of claim 11, wherein manipulating the activity record responsive to the rule comprises:
identifying a trigger event defined by the rule; and
setting the activity value defined by a plurality of rule attributes of the rule.

13. The system of claim 11, wherein manipulating the activity record responsive to the rule comprises:
extracting adjustment information from an adjustment message received responsive to a user interface display of the activity record; and
manipulating the activity record responsive to the adjustment information.

14. The system of claim 11, wherein adjustment information, extracted from an adjustment message received responsive to a user interface display of the activity record, comprises an adjustment image corresponding to the adjustment message.

15. The system of claim 11, wherein adjusting the user interface responsive to the activity report comprises:
modifying a list view displaying a plurality of activity records, comprising the activity record, by one or more of resizing the list view, adjusting a font size, and adjusting a font color responsive to the activity record.

16. The system of claim 11, wherein the plurality of rule attributes are set with an administrator device, and wherein the plurality of rule attributes comprises a work type, a work trigger event, an activity amount, and an activity percentage.

17. The system of claim 11, wherein the plurality of rule attributes comprises a rule attribute set with an administrator device, and wherein the rule attribute comprises an activity record type to identify a type of an activity record.

18. The system of claim 11, wherein the plurality of rule attributes comprises a rule attribute set with an administrator device, and wherein the rule attribute comprises a flat amount value.

19. The system of claim 11, wherein the activity record corresponds to a user identified in a user profile comprising an additional value field used to generate the activity report.

20. A non-transitory computer readable storage medium storing computer readable program code which, when executed by a processor, performs a computer-implemented method comprising:
extracting work information from a work message to adjust a work record;
manipulating an activity record responsive to the work record and a rule comprising a plurality of rule attributes to set an activity value of the activity record;
processing the activity record to generate an activity report comprising the activity value; and
adjusting a user interface responsive to the activity report.
